(19) United States
(12) Patent Application Publication
(10) Pub. No.: US 2026/0178512 A1
(43) Pub. Date: Jun. 25, 2026

(54) PROCESSING SYSTEM AND CORRESPONDING METHOD

(71) Applicant: STMicroelectronics International N.V., Geneva (CH)

(72) Inventors: Rosalino CRITELLI, San Pietro Clarenza (IT); Alessio SIPALA, Siracusa (IT)

(73) Assignee: STMicroelectronics International N.V., Geneva (CH)

(21) Appl. No.: 19/424,890

(22) Filed: Dec. 18, 2025

(30) Foreign Application Priority Data
Dec. 24, 2024 (IT) 102024000029892

(51) Int. Cl. G06F 12/14; H04L 9/06

(52) U.S. Cl. CPC G06F 12/1408; H04L 9/0618; G06F 2212/1052

(57) ABSTRACT

A processing system includes a processing circuit, memory controller, and memory cipher engine. The memory cipher engine receives a write request from the processing circuit to a first address and determines address data for a memory area containing the first address. This address data is provided to a block-cipher cryptographic circuit, which generates an encrypted address upon request. During this process, the memory cipher engine de-asserts a ready signal to the processing circuit and sets a data signal to the memory controller to a default value. After the block-cipher cryptographic circuit signals encryption readiness, the memory cipher engine issues a write request to the memory controller for the first address. In the subsequent data phase, it provides a value to the memory controller generated by combining the original data with part of the encrypted address. The cipher engine waits for completion and re-asserts the ready signal.

### PRIORITY CLAIM

This application claims the priority benefit of Italian Application for Patent No. 102024000029892 filed on Dec. 24, 2024, the content of which is hereby incorporated by reference in its entirety to the maximum extent allowable by law.

### TECHNICAL FIELD

The description relates to solutions for encrypting and decrypting data in a microcontroller. Specifically, various embodiments of the present disclosure relate to solutions for storing encrypted data to a memory being external with respect to the microcontroller.

### BACKGROUND

FIG. 1 shows a typical electronic system, such as the electronic system of a vehicle, comprising a plurality of processing systems 10, such as embedded systems or integrated circuits, e.g., a Field Programmable Gate Array (FPGA), a Digital Signal Processor (DSP), or a microcontroller (e.g., dedicated to the automotive market).

For example, FIG. 1 illustrates three processing (P) systems 10₁, 10₂, and 10₃ connected through a suitable communication system 20. The communication system may include a vehicle control bus, such as a Controller Area Network (CAN) or Ethernet bus, and possibly a multimedia bus, such as a Media Oriented Systems Transport (MOST) bus, connected to the vehicle control bus via a gateway. Typically, the processing systems 10 are located at different positions in the vehicle and may include, for example, an Engine Control Unit, a Transmission Control Unit (TCU), an Anti-lock Braking System (ABS), a Body Control Module (BCM), and/or a navigation and/or multimedia audio system. Accordingly, one or more of the processing systems 10 may also implement real-time control and regulation functions. These processing systems are usually identified as Electronic Control Units (ECUs).

FIG. 2 shows a block diagram of an exemplary processing system 10, such as a microcontroller, which may be used as any of the processing systems 10 of FIG. 1.

In the example considered, the processing system 10 comprises a digital processing core 102. For example, the processing core 102 may comprise a microprocessor 102, usually the Central Processing Unit (CPU), programmed via software instructions. Typically, the software executed by the microprocessor 102 is stored in a non-volatile program memory (NVM) 104, such as Flash memory or EEPROM. Similarly, if the processing core 102 comprises an FPGA, the programming data for the FPGA 102 may be stored in the non-volatile memory 104. Thus, memory 104 is configured to store the firmware of the processing core 102, where the firmware may include the software instructions to be executed by a microprocessor 102 and/or the programming data for an FPGA or other types of programmable logic circuits. Generally, the non-volatile memory 104 may also be used to store other data, such as configuration data (e.g., calibration data).

The processing core 102 usually also has an associated volatile memory 104b, such as Random-Access Memory (RAM). For example, memory 104b may be used to store temporary data.

As shown in FIG. 2, communication with memories 104 and/or 104b is usually performed via one or more memory controllers (MC) 100. The memory controller(s) 100 may be integrated into the processing core 102 or connected to the processing core 102 via a communication channel, such as a system bus of the processing system 10. Similarly, memories 104 and/or 104b may be integrated with the processing core 102 in a single integrated circuit, or may be separate integrated circuits connected to the processing core 102, for example, via the traces of a printed circuit board.

In the example considered, the processing core 102 may have associated one or more hardware resources/peripherals 106 selected from the group consisting of: one or more communication interfaces IF, e.g., for exchanging data via the communication system 20, such as a Universal Asynchronous Receiver/Transmitter (UART), Serial Peripheral Interface Bus (SPI), Inter-Integrated Circuit (I2C), Controller Area Network (CAN) bus, Ethernet interface, and/or a debug interface; and/or one or more analog-to-digital converters (AD) and/or digital-to-analog converters (DA); and/or one or more dedicated digital components (DC), such as hardware timers, counters, and/or co-processors; and/or one or more analog components (AC), such as comparators, sensors (e.g., a temperature sensor), etc.; and/or one or more mixed-signal components (MSC), such as a Pulse-Width Modulation (PWM) driver.

Accordingly, the processing system 10 may support different functionalities. For example, the behavior of the processing core 102 is determined by the firmware stored in memory 104, i.e., the software instructions to be executed by a microprocessor 102 of a microcontroller 10. Thus, by installing different firmware, the same hardware (microcontroller) can be used for different applications.

In this respect, future generations of such processing systems 10, e.g., microcontrollers adapted for automotive applications, are expected to exhibit increased complexity, mainly due to the growing number of required functionalities (new protocols, new features, etc.) and the tight constraints of execution conditions (e.g., lower power consumption, increased computational power and speed, etc.).

For example, more complex multi-core processing systems 10 have recently been proposed. Such multi-core processing systems may be used to execute (in parallel) several of the processing systems 10 shown in FIG. 1, such as several ECUs of a vehicle. Additionally, more complex co-processors have been proposed. These co-processors may support different functionalities, and the specific operation to be executed may be programmable.

FIG. 3 shows another example of a processing system 10, such as a multi-core processing system 10. Specifically, in the example considered, the processing system 10 comprises a plurality of n processing cores 102₁, . . . , 102ₙ connected to an on-chip communication system 114. For example, in the context of real-time control systems, the processing cores 102₁, . . . , 102ₙ may be ARM Cortex®-R52 cores. Generally, the communication system 114 may comprise one or more bus systems, e.g., based on the Advanced eXtensible Interface (AXI) bus architecture, and/or a Network-on-Chip (NoC).

For example, as shown for processing core 1021, each processing core 102 may comprise a microprocessor (MP) 1020 and a communication interface (IF) 1022 configured to manage communication between the microprocessor 1020 and the communication system 114. Typically, interface 1022 is a master interface configured to forward a given (read or write) request from the microprocessor 1020 to the communication system 114, and forward an optional response from the communication system 114 to the microprocessor 1020. However, communication interface 1022 may also comprise a slave interface. In this way, a first microprocessor 1020 may send a request to a second microprocessor 1020 (via the communication interface 1022 of the first microprocessor, the communication system 114, and the communication interface 1022 of the second microprocessor). Generally, each processing core 102₁, . . . , 102ₙ may also comprise additional local resources, such as one or more local memories 1026, usually identified as Tightly Coupled Memory (TCM).

As mentioned previously, the processing cores 102₁, . . . , 102ₙ are typically arranged to exchange data with one or more non-volatile memories 104 and/or one or more volatile memories 104b. In a multi-core processing system 10, these memories are often system memories, i.e., shared among the processing cores 1021, . . . , 102n. However, each processing core 102₁, . . . , 102ₙ may also comprise additional local memories 1026. For example, as shown in FIG. 3, the processing system 10 may comprise one or more memory controllers 100 configured to connect at least one non-volatile memory 104 and at least one volatile memory 104b to the communication system 114.

As mentioned previously, the processing system 10 may comprise one or more resources 106, such as communication interfaces or co-processors. The resources 106 are usually connected to the communication system 114 via a respective communication interface 1062, such as a peripheral bridge. For example, the communication system 114 may comprise an Advanced Microcontroller Bus Architecture (AMBA) High-performance Bus (AHB), and an Advanced Peripheral Bus (APB) used to connect the resources/peripherals 106 to the AMBAAHB bus. Usually, communication interface 1062 comprises at least a slave interface. In this way, a processing core 102 may send a request to a resource 106, and the resource returns data. Generally, one or more of the communication interfaces 1062 may also comprise a master interface. Such a master interface, often identified as an integrated Direct Memory Access (DMA) controller, may be useful if the resource needs to initiate communication to exchange data via (read and/or write) requests with another circuit connected to the communication system 114, such as another resource 106, a processing core 102, or a memory controller 100.

Often, such processing systems 10 also comprise one or more general-purpose DMA controllers 102. For example, as shown in FIG. 3, a DMA controller 100 may be used to directly exchange data with a memory, e.g., memory 104b, based on requests received from a resource 106. In this way, a communication interface may directly read data (via the DMA controller 100) from memory 104b and transmit these data, without having to exchange further data with a processing unit 102. Generally, a DMA controller 100 may communicate with the memory or memories via the communication system 114 or via dedicated communication channels.

As mentioned previously, the memory controller 100 is often used to interface an external memory, such as a non-volatile memory 104 and/or a volatile memory 104a. For security reasons, it is advantageous for data stored in the external memory to be encrypted.

In this respect, many modern processing systems 10 comprise a cryptographic co-processor, such as an AES co-processor. For example, the cryptographic co-processor may be a peripheral 106 connected to the communication system 114, where a microprocessor 102 may send a request to execute a cryptographic operation (e.g., encrypt or decrypt data) by sending one or more write requests via the communication system 114 to the cryptographic co-processor. The write requests may select a cryptographic operation, provide the data to be processed, and optionally set configuration data for the cryptographic operation. This procedure may involve configuring AES settings, loading encryption keys, setting up data transfer parameters, and triggering encryption by writing to a specific register. Once encryption is complete, the microprocessor 102 may read the processed (e.g., encrypted or decrypted) data. This solution is usually used when a small amount of data must be processed. While this approach offers flexibility, it has the drawback of increased CPU overhead and poor optimization for real-time or high-throughput encryption of data.

Accordingly, as disclosed, for example, in European Patent document EP 4 095 704 A1, the cryptographic co-processor may be associated with one or more DMA controllers, such as integrated DMA controllers or general-purpose DMA controllers 110, which are configured to transfer the data to be processed from a first address (such as an address associated with memory 104b) to the cryptographic co-processor and transfer the processed data to a second address. This solution is usually used when a larger amount of data must be processed. Such solutions are often used when the cryptographic co-processor is used to encrypt data to be transmitted via a communication interface IF, or to decrypt data received via a communication interface IF. However, the DMA controllers could also be configured to read plain data from a memory address associated with a memory integrated in the processing system 10 and then transfer the encrypted data to a memory address associated with a memory external to the processing system 10. Similarly, the DMA controllers could be configured to read encrypted data from a memory address associated with the external memory and then transfer the decrypted/plain data to a memory address associated with the internal memory. However, in this way, the processing core 102 may only access the data in the internal memory, and significant latency is introduced for exchanging data with the external memory.

Accordingly, solutions are known in which the memory controller 100 is modified to support cryptographic operations. For example, the memory controller 100 may comprise a cryptographic processing circuit used to encrypt/decrypt data on the fly, i.e., in real time, as data is exchanged with an external memory. Such solutions are often used to interface external RAM memories. For example, this solution is implemented in STM32H7Sx microcontrollers. Similarly, such a solution is often used to read encrypted firmware from an external non-volatile memory 104. For example, such a solution is disclosed in document Application AN6088, “How to use MCE for encryption/decryption on STM32 MCUs”, April 2024.

There is a need in the art to contribute to addressing the issues discussed above.

### SUMMARY

According to one or more embodiments, one or more of the above objectives are achieved by means of a processing system. Embodiments also concern a corresponding method.

The scope of protection is defined in the enclosed claims, which are an integral part of the technical teaching provided herein.

As mentioned previously, various embodiments of the present disclosure relate to a processing system comprising a processing circuit and a memory controller configured to interface with a memory. The memory comprises a plurality of memory slots, with each memory slot having a given number N of bytes.

In various embodiments, the processing system also comprises a memory cipher engine circuit. The memory cipher engine circuit comprises a slave interface connected via a first communication system to the processing circuit and a master interface connected via a second communication system to the memory controller. Specifically, in various embodiments, the first and second communication systems are configured to communicate a write request by transmitting, in an address phase, first and second address signals, respectively, and first and second control signals, respectively, indicating a write request, and in a following data phase, first and second data signals, respectively, indicating the data associated with the write request. Moreover, the first and second communication systems comprise a first and second ready signal, respectively, indicating the completion of a write request. For example, in various embodiments, each of the first and second communication systems is an Advanced Microcontroller Bus Architecture (AMBA) High-performance Bus (AHB) or an AHB Lite bus.

In various embodiments, the memory cipher engine circuit comprises a block-cipher cryptographic circuit configured to generate an encrypted address having a given number K of bytes, with each encrypted address associated with a given memory area of K bytes in the memory. For this purpose, the block-cipher cryptographic circuit is configured to receive an encryption-request signal and an address signal indicating a given memory area of K bytes in the memory. In response to determining that the encryption-request signal is asserted, the block-cipher cryptographic circuit computes the encrypted address as a function of the address signal and, once the computation of the encrypted address is complete, asserts an encryption-ready signal. For example, the block-cipher cryptographic circuit may be an AES cryptographic circuit using 16 or 32 bytes, with the AES circuit used in counter mode. For example, the memory cipher engine circuit may determine the address data indicating a memory area of K bytes in the memory as a function of a given number of most significant bits of the first address signal.

According to a first aspect of the present disclosure, the memory cipher engine circuit is configured to receive from the processing circuit, via the first address signal and the first control signals, a write request to a first address. In response to receiving the write request to the first address, the memory cipher engine circuit determines address data indicating a memory area of K bytes in the memory comprising the first address and stores the address data. Moreover, the memory cipher engine circuit de-asserts the first ready signal provided to the processing circuit and sets the second data signal to a given value, such as 0x00. In various embodiments, the memory cipher engine circuit sets the second control signals to place the second communication system in an idle state.

In various embodiments, the memory cipher engine circuit also provides the address data to the block-cipher cryptographic circuit and asserts the encryption-request signal, whereby the block-cipher cryptographic circuit generates the encrypted address data. The memory cipher engine circuit then waits until the encryption-ready signal is asserted.

In various embodiments, in response to determining that the encryption-ready signal is asserted, the memory cipher engine circuit sets the second address signal and the second control signals to indicate a write request to the first address and, in a following data phase, sets the second data signal to a value generated by combining data received via the first data signal with part of the encrypted address, preferably via a combinational logic operation. For example, in various embodiments, the memory cipher engine circuit is configured to combine the data received with the first data signal with part of the encrypted address by splitting the encrypted address into K/N subsets of bits and selecting one of the subsets as a function of a given number of least significant bits of the first address signal. Next, the memory cipher engine circuit sets the second data signal to a value generated by combining data received via the first data signal with the selected subset of bits via a logic XOR operation.

In various embodiments, the memory cipher engine circuit then waits until the second ready signal received from the memory controller is asserted. In response to determining that the second ready signal is asserted, the memory cipher engine circuit asserts the first ready signal, thereby indicating the completion of the write request by the memory controller.

According to a second aspect of the present disclosure, the write request to the first address indicates a non-sequential transmission, and the memory cipher engine circuit receives a further write request to a second address, where the write request to the second address also indicates a non-sequential transmission. In this case, the memory cipher engine circuit determines address data indicating a memory area of K bytes in the memory comprising the second address and determines whether the determined address data correspond to the stored address data (e.g., associated with the first address).

In various embodiments, in response to determining that the determined address data correspond to the stored address data, the memory cipher engine circuit omits the calculation of the encrypted address. In this case, the memory cipher engine circuit may forward the first address signal and the first control signals as the second address signal and the second control signals, thereby indicating a write request to the second address and, in a following data phase, set the second data signal to a value generated by combining data received with the first data signal with part of the encrypted address. Similarly, the memory cipher engine circuit may forward the response from the memory controller, i.e., the memory cipher engine circuit may forward the second ready signal received from the memory controller as the first ready signal. Accordingly, in this case, the memory cipher engine circuit forwards the write request and the respective response essentially in a transparent manner, while simply replacing the data received with the first data signal with the respective encrypted data calculated on-the-fly.

Conversely, in various embodiments, in response to determining that the determined address data do not correspond to the stored address data, the memory cipher engine circuit recalculates the encrypted address data and thus suspends communication with the processing system in the meantime. Specifically, in various embodiments, the memory cipher engine circuit provides the determined address data to the block-cipher cryptographic circuit, asserts the encryption-request signal, and stores the determined address data, thereby indicating the address of the memory area for which the new encrypted address is valid. Moreover, the memory cipher engine circuit de-asserts the first ready signal provided to the processing circuit, thereby suspending communication with the processing circuit, and sets the second data signal to a given value, such as 0x00, thereby masking the value of the second data signal provided to the memory controller. In various embodiments, the memory cipher engine circuit also sets the second control signals to place the second communication system in an idle state.

In various embodiments, the memory cipher engine circuit then waits until the encryption-ready signal is asserted. In response to determining that the encryption-ready signal is asserted, the memory cipher engine circuit sets the second address signal and the second control signals to indicate a non-sequential write request to the second address and, in a following data phase, sets the second data signal to a value generated by combining data received with the first data signal with part of the encrypted address. Accordingly, in this way, the memory cipher engine circuit generates a new non-sequential write request which is transmitted to the memory controller.

In various embodiments, the memory cipher engine circuit then waits until the second ready signal received from the memory controller is asserted. In response to determining that the second ready signal is asserted, the memory cipher engine circuit asserts the first ready signal. Accordingly, in this way, the memory cipher engine circuit forwards the response from the memory controller to the processing circuit.

According to a third aspect of the present disclosure, the write request to the first address indicates a non-sequential transmission, and the memory cipher engine circuit is configured to receive a write request to a third address, where the write request to the third address indicates a sequential transmission. In general, the term “third address” is used only to distinguish this address from the “second address,” and the wording does not imply that the write request to the second address has been received, or that the write request to the second address has been received before the write request to the third address.

Also in this case, the memory cipher engine circuit determines address data indicating a memory area of K bytes in the memory comprising the third address and determines whether the determined address data correspond to the stored address data (e.g., associated with the first or second address).

In various embodiments, in response to determining that the determined address data correspond to the stored address data, the memory cipher engine circuit may again forward the first address signal and the first control signals as the second address signal and the second control signals, thereby indicating a write request to the third address and, in a following data phase, set the second data signal to a value generated by combining data received with the first data signal with part of the encrypted address. Similarly, the memory cipher engine circuit may forward the second ready signal received from the memory controller as the first ready signal.

Conversely, in response to determining that the determined address data do not correspond to the stored address data, the memory cipher engine circuit stores the determined address data, provides the determined address data to the block-cipher cryptographic circuit, and asserts the encryption-request signal. Moreover, the memory cipher engine circuit de-asserts the first ready signal provided to the processing circuit, thereby suspending communication with the processing circuit, and sets the second data signal to a given value, such as 0x00, thereby masking the value of the second data signal provided to the memory controller. In various embodiments, the memory cipher engine circuit also sets the second control signals to place the second communication system in an idle state. Specifically, due to the sequential transfer, this operation may cause the memory controller to write the given value to the third address.

In various embodiments, the memory cipher engine circuit waits until the encryption-ready signal is asserted. In response to determining that the encryption-ready signal is asserted, the memory cipher engine circuit sets the second address signal and the second control signals to indicate a non-sequential write request to the third address.

Thus, in various embodiments, the memory cipher engine circuit interrupts the sequential communication with the memory controller and then signals a new non-sequential write request. However, the interruption of the sequential communication with the memory controller via the idle state may cause the memory controller to write the given value to the third address. However, the respective confirmation/pulse in the second ready signal should not be communicated to the processing circuit, but only the next pulse which indicates the completion of the new non-sequential write request.

For this purpose, in various embodiments, the memory cipher engine circuit waits until the second ready signal received from the memory controller is asserted. In response to determining that the second ready signal received from the memory controller is asserted, the memory cipher engine circuit maintains the first ready signal provided to the processing circuit de-asserted, i.e., the response is not propagated to the processing system. In fact, as mentioned before, this response may be associated with a non-sequential write request of the given value to the third address. Moreover, since the memory cipher engine circuit has already provided a new non-sequential write request to the third address, the memory cipher engine circuit may set the second data signal to a value generated by combining data received with the first data signal with part of the encrypted address, which corresponds to the data phase of the (new) non-sequential write request to the third address.

In various embodiments, the memory cipher engine circuit then waits until the second ready signal received from the memory controller is asserted, and in response to determining that the second ready signal is asserted, asserts the first ready signal.

Thus, in various embodiments, in response to receiving a sequential write request to the third address, the memory cipher engine circuit may suspend the sequential communication with the processing system via the first ready signal. Moreover, the memory cipher engine circuit interrupts the sequential communication with the memory controller by placing the second communication system in the idle state, while providing the given data. Next, once the new encrypted address has been calculated, the memory cipher engine circuit communicates a new non-sequential write request to the third address with the encrypted data, while also masking the first response received from the memory controller.

In various embodiments, to implement the above operations, the memory cipher engine circuit comprises an address comparison circuit, a transfer management circuit, a buffer circuit, an encryption management circuit, and a flow-control circuit.

In various embodiments, the address comparison circuit comprises a memory, e.g., a register, configured to store address data, wherein the address comparison circuit is configured to determine address data indicating a memory area of K bytes in the memory comprising the address transmitted with the first address signal and whether the determined address data correspond to the stored address data. In response to determining that the determined address data correspond to the stored address data, the address comparison circuit asserts the encryption-request signal and stores the determined address data.

In various embodiments, the transfer management circuit is configured to receive a first transfer type signal and a first burst type signal from the processing circuit, and generate a second transfer type signal and a second burst type signal for the memory controller as a function of first flow-control signals. Substantially, in various embodiments, the transfer management circuit is configured to provide the first transfer type signal and a first burst type signal, or a transfer type signal indicating a non-sequential data transmission or an idle state based on the first flow-control signals.

In various embodiments, the buffer circuit is configured to receive the first address signal and a first transfer direction signal from the processing circuit, and generate the second address signal and a second transfer direction signal for the memory controller as a function of second flow-control signals. Substantially, in various embodiments, the buffer circuit provides the first transfer direction signal and the first address signal or stored versions of the first transfer direction signal and the first address signal based on the second flow-control signals.

In various embodiments, the encryption management circuit comprises the block-cipher cryptographic circuit. The encryption management circuit is configured to receive the first data signal and generate the second data signal as a function of third flow-control signals. Substantially, in various embodiments, the encryption management circuit provides the given value or the encrypted data value based on the third flow-control signals.

In various embodiments, the flow-control circuit is configured to receive the first transfer direction signal and the first transfer type signal from the processing circuit and the encryption-request signal from the address comparison circuit, and generate the first flow-control signals, the second flow-control signals, and the third flow-control signals.

For example, in various embodiments, the flow-control circuit is configured to determine whether a new write request is received and the encryption-request signal is asserted. In fact, this condition signals that the encrypted address must be recalculated. As mentioned before, in various embodiments, the memory cipher engine circuit suspends communication with the processing circuit in this case, and interrupts communication with the memory controller by setting the communication with the memory controller in the idle state until the block-cipher cryptographic circuit asserts the encryption-ready signal. Moreover, in response to the encryption-ready signal, the memory cipher engine circuit generates a new non-sequential communication.

For example, for this purpose, in response to determining that the new write request is received and the encryption-request signal is asserted, the flow-control circuit asserts a postpone-write-request control signal, which indicates that communication with the memory controller should be delayed until the encrypted address has been calculated. Accordingly, in response to determining that the encryption-ready signal is asserted, the flow-control circuit may assert a write-request control signal and de-assert the postpone-write-request control signal. Accordingly, the write-request control signal indicates that the address phase of a (new) non-sequential write request with the memory controller may be started.

Moreover, the flow-control circuit may be configured to forward the response from the memory controller to the processing circuit. However, since a response to an interrupted sequential communication should not be forwarded, the flow-control circuit may also detect this situation. For example, in various embodiments, the flow-control circuit is configured to determine whether a new sequential or non-sequential write request is received and whether the encryption-request signal is asserted.

For example, in response to determining that a new non-sequential write request is received and the encryption-request signal is asserted, the flow-control circuit determines whether the encryption-ready signal is asserted. When the encryption-ready signal is de-asserted, i.e., when an encryption operation is still pending, the flow-control circuit de-asserts the first ready signal, thereby suspending communication with the processing circuit. In the meantime, the encryption management circuit computes the encrypted address and the flow-control circuit manages the generation of the write-request control signal as described above. Thus, once the encryption-ready signal is asserted, the flow-control circuit may provide the second ready signal as the first ready signal, thereby forwarding the response from the memory controller to the processing circuit.

Conversely, in response to determining that a new sequential write request is received and the encryption-request signal is asserted, communication with the processing circuit should be suspended and communication with the memory controller should be interrupted in order to generate, once the encrypted address has been computed, a new non-sequential write request. However, when interrupting the sequential transmission, the memory controller may execute the write request of the given data and assert the second ready signal. However, this pulse in the second ready signal should not be propagated to the processing circuit.

For this purpose, the flow-control circuit may assert a ready control signal, wherein the flow-control circuit is configured to maintain the first ready signal de-asserted while the ready control signal is asserted and, in response to determining that the second ready signal received from the memory controller is asserted, de-assert the ready control signal. Accordingly, in this way, the first confirmation/pulse in the second ready signal is not propagated, because the first ready signal remains de-asserted.

As mentioned before, when a write request is postponed, the second data signal may be set to a given value. For example, in various embodiments, the encryption management circuit may determine whether the postpone-write-request control signal is asserted or the ready control signal is asserted. In response to determining that the postpone-write-request control signal is asserted or the ready control signal is asserted, the encryption management circuit may provide the given value as the second data signal. Conversely, in response to determining that the postpone-write-request control signal and the ready control signal are de-asserted, the encryption management circuit may set the second data signal to the value generated by combining data received via the first data signal with part of the encrypted address.

Conversely, the transfer management circuit may forward the requests when the encrypted address does not have to be recalculated. For example, in various embodiments, in response to determining that a new sequential or non-sequential write request is received and the encryption-request signal is de-asserted, the flow-control circuit may set the first flow-control signals, such that the transfer management circuit provides the first transfer type signal.

Conversely, in various embodiments, when an encryption operation is requested, the flow-control circuit postpones the write request by placing the second communication system in the idle state and then generating a new non-sequential write request. For example, in response to determining that a new non-sequential write request is received and the encryption-request signal is asserted, the flow-control circuit sets the first flow-control signals so that the transfer management circuit provides the value indicating an idle state until the write-request control signal is asserted, and then the value indicating a non-sequential data transmission. Specifically, in this way, communication with the memory controller is maintained in the idle state until the encryption-ready signal is asserted, and then a non-sequential write request is transmitted to the memory controller.

Similarly, in response to determining that a new sequential write request is received and the encryption-request signal is asserted, the flow-control circuit may set the first flow-control signals so that the transfer management circuit provides the value indicating an idle state until the write-request control signal is asserted, and then the value indicating a non-sequential data transmission. Specifically, in this way, sequential communication with the memory controller is interrupted and a new non-sequential write request is transmitted to the memory controller.

Accordingly, in various embodiments, the buffer circuit is configured to provide (by default) the first address signal as the second address signal. However, in response to determining that the write-request control signal is asserted—i.e., when a postponed write request is transmitted to the memory controller—the buffer circuit provides a stored version of the first address signal as the second address signal, thereby indicating the address associated with the postponed write request.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIGS. 1 to 3 show examples of processing systems;

FIG. 4 illustrates an embodiment of a processing system, such as a microcontroller, comprising a memory cipher engine circuit according to the present disclosure;

FIGS. 5A and 5B show a counter mode of a block-cipher cryptographic operation;

FIG. 6 shows an embodiment of a memory area arranged to store an encrypted data block;

FIG. 7 shows an embodiment of a generation of the encrypted data for the memory area of FIG. 6;

FIG. 8 shows an embodiment of a cryptographic circuit for the memory cipher engine circuit of FIG. 4, wherein the cryptographic circuit is arranged to generate encrypted data as a function of address data;

FIGS. 9 and 10 show examples of data transmission operations with the memory cipher engine circuit of FIG. 4;

FIG. 11 illustrates an exemplary master device of an integrated circuit communication system;

FIG. 12 illustrates an exemplary slave device of an integrated circuit communication system;

FIG. 13 illustrates exemplary waveforms representing signals transmitted between the master device and the slave device during a read request;

FIG. 14 illustrates waveforms representing signals transmitted between a master device and a slave device during a write request;

FIG. 15 illustrates a further embodiment of a memory cipher engine circuit according to the present disclosure;

FIGS. 16A and 16B illustrate waveforms representing signals transmitted during a single mode write transaction;

FIG. 17 illustrates a detailed schematic of a flow-control circuit for the memory cipher engine circuit of FIG. 15;

FIG. 18 shows an example of a burst mode data transmission operation with the memory cipher engine circuit of FIG. 4;

FIGS. 19A and 19B illustrate waveforms representing signals transmitted during a burst mode write transaction; and

FIG. 20 illustrates a further detailed schematic of a flow-control circuit for the memory cipher engine circuit of FIG. 15.

In order to favor the clarity of the features shown, the figures may be drawn in simplified fashion, are not necessarily drawn to scale, and the edges of the figures may not necessarily indicate termination of the extent of the feature.

### DETAILED DESCRIPTION

In the figures and in the rest of the description, like features have been designated by like references in the various figures; as such, a corresponding description may not be repeated for the sake of brevity. In particular, the structural and/or functional features that are common amongst the various embodiments may have the same references and may have identical structural, dimensional, and material properties. Finally, the different embodiments and variants are not exclusive to one another and can be combined amongst themselves.

The references used herein are provided merely for convenience and hence do not define the extent of protection or the scope of the embodiments.

In the ensuing description, one or more specific details are illustrated, aimed at providing an in-depth understanding of embodiments of this invention. The embodiments may be implemented without one or more of the specific details, or with other methods, components, materials, etc. In some cases, known structures, materials, or operations may not be illustrated or described in detail so as to not lose focus on the main aspects of embodiments of the invention.

Reference to “an embodiment” or “one embodiment” in the present description should be understood as meaning “at least one embodiment”. Moreover, phrases such as “in an embodiment” or “in one embodiment” that may be present in one or more points of the present description do not necessarily refer to one and the same embodiment. Moreover, particular configurations, structures, or characteristics may be combined in any manner known to skilled persons in one or more other embodiments.

Unless indicated otherwise, when reference is made to two elements directly connected together, this signifies direct contact of one element to the other without any intermediate elements. When reference is made to two elements connected or coupled together, this signifies that these two elements can be either directly connected or they can be indirectly connected via one or more other intermediate elements.

Unless specified otherwise, the expressions “about”, “around”, “approximately”, “substantially” and “in the order of” signify within 10% or 10°, and preferably within 5% or 5°. Additionally, the phrase “comprised between . . . and . . . ” or equivalent signifies that the end points are included, unless otherwise indicated.

Where not otherwise defined, all technical and scientific terms used herein have the same meaning commonly used by skilled persons in the field pertaining to the present invention. The views included in the attached figures and described herein are not intended as representations of structural features, i.e., constructional limitations, but should be interpreted as representations of functional features, i.e., functions that can be implemented in different ways.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a . . . as orientated during use as described in the description, but not limited thereby.

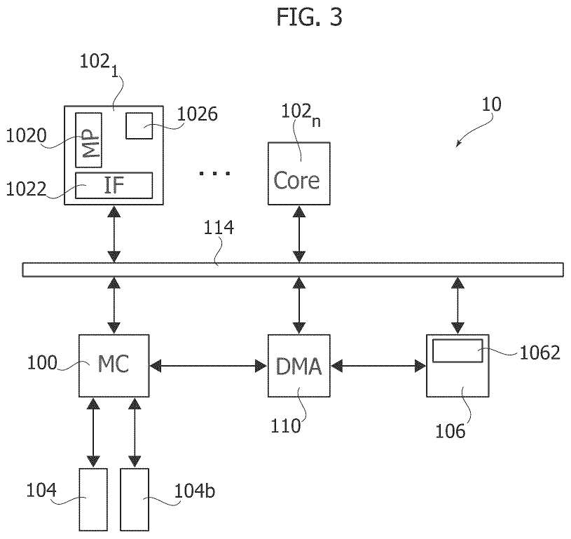

FIG. 4 illustrates an embodiment of a processing system 10a according to the present disclosure. Specifically, in the embodiment considered, the processing system 10a comprises a processing core 102. As described above, the processing core 102 may comprise a microprocessor 1020 programmed via software instructions.

In various embodiments, the processing system 10a also comprises a memory controller 100 configured to interface with an external memory 50, such as a non-volatile memory 104 or a volatile memory 104b, including flash memory, PSRAM, SDRAM, or FRAM. For example, FIG. 4 schematically shows an I/O circuit 101 comprising input and/or output terminals arranged to connect the external memory 50 to the memory controller 100. In general, the memory controller 100 may support any suitable communication protocol to interface with the external memory 50, including serial and/or parallel communications.

In various embodiments, the memory 50 may correspond to the non-volatile program memory 104 used to store the firmware of the microprocessor 1020. For example, in this case, the processing core 102 may also comprise an instruction register and/or cache 1028. Additionally or alternatively, the memory 50 may be a volatile or non-volatile memory used to store user data. For example, in this case, the processing core 102 may also comprise a data cache 1030.

Accordingly, in various embodiments, the processing core 102 is able to read data from the external memory 50 by sending read requests to the memory controller 100, for example, to read software instructions from the memory 50.

As mentioned previously, to support encrypted data stored in the memory 50, the memory controller 100 could be modified to include a cryptographic processing circuit. However, in the embodiment considered, the processing system 10a comprises an additional memory cipher engine circuit 30.

Specifically, in various embodiments, the memory cipher engine circuit 30 comprises a slave interface 300, which is connected via a communication system 114 to the processing core 102, for example, to a respective master interface 1022. Moreover, in various embodiments, the memory cipher engine circuit 30 comprises a master interface 302 connected to the memory controller 100 via a further communication system 115. In various embodiments, each of the communication systems 114 and 115 may be a system bus and may be implemented, for example, in accordance with the Advanced Microcontroller Bus Architecture (AMBA) standard. For instance, in various embodiments, bus 114 and/or bus 115 are implemented with an Advanced High-performance Bus (AHB) or an AHB-Lite bus.

Accordingly, in various embodiments, the memory cipher engine circuit 30 may be used to interface, via the slave interface 300, a standard processing core 102 and, via the master interface 302, a standard memory controller 100.

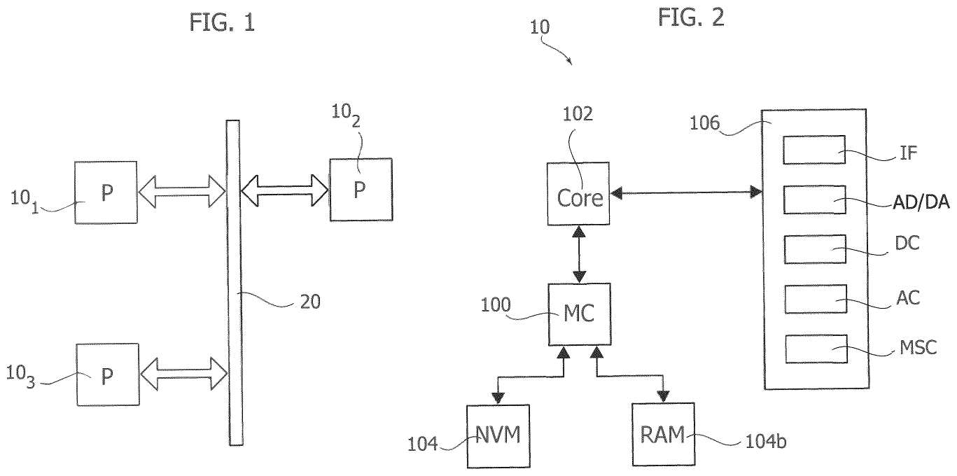

While not shown in FIG. 4, the processing system 10a may also comprise additional circuits, such as one or more peripherals 106, internal memories 104 and/or 104b, and/or DMA controllers 102. For these circuits, reference is made to the description of FIGS. 1 to 3.

Accordingly, in the embodiments considered, the processing core 102 may interface with the circuits connected to the communication systems 114 by sending read and write requests that include an address associated with the respective circuit. Specifically, as is well known, each of the slave interfaces connected to the communication system 114 may have one or more associated addresses within the communication system 114. Typically, the addresses of the communication system 114 are identified as physical addresses, because the processing core 102 may also implement an additional virtual address translation operation.

For example, in various embodiments, a given physical address range may be associated with each peripheral 106 connected to the communication system 114. Usually, a given address range is associated with a peripheral bridge used to interface one or more peripherals 106. In this case, a peripheral bridge may be configured to map the physical address to a respective register of one or more peripherals 106.

Similarly, in the processing systems described with respect to FIGS. 2 and 3, a given physical address range would be associated with the memory controller 100. In this case, the memory controller is configured to map the physical address to a respective memory address of the memory 50.

For example, in response to receiving a read request comprising a given physical memory address, the memory controller 100 may determine the respective memory address and generate the communication needed to send a read request via the I/O circuit 101 to the external memory 50. Once data is received from the external memory 50, the memory controller 100 may generate a response to the read request in order to return the data to the master interface that sent the read request, for example, the processing core 102.

Conversely, in response to receiving a write request comprising a given physical memory address and respective data to be written, the memory controller 100 may determine the respective memory address and generate the communication needed to send a write request via the I/O circuit 101 to the external memory 50. Once the data has been stored in the external memory 50, the memory controller 100 may generate a response to the write request to indicate completion.

In the embodiment considered, the memory controller 100 continues to operate in this manner, but the memory cipher engine circuit 30 is configured to interface the memory controller 100 with the communication system 114 in a transparent manner. Accordingly, in various embodiments, the memory cipher engine circuit 30 is associated with a given physical address range of the communication system 114. In response to receiving a read request via the slave interface 300, the memory cipher engine circuit 30 may transmit a read request via the master interface 302 to the communication system 115. Similarly, in response to receiving a write request via the slave interface 300, the memory cipher engine circuit 30 may transmit a write request via the master interface 302 to the communication system 115.

In various embodiments, the memory controller 100 and the slave interface 300 use the same physical address range. In this way, the memory cipher engine circuit 30 may simply include the physical address of the request received via the slave interface 300 in the respective request transmitted via the master interface 302. For example, this is schematically shown in FIG. 4, where the slave interface provides the received address ADR directly to the master interface 302. However, in various embodiments, the memory cipher engine circuit 30 could also implement an address mapping operation, although this introduces further complexity and latency.

Accordingly, in various embodiments, the memory cipher engine circuit 30 may receive via the interface 300 a write request comprising (plain) data D1. In response to receiving the write request, the memory cipher engine circuit 30 may process the data D1 to generate encrypted data D2. Once the encrypted data D2 has been generated, the memory cipher engine circuit 30 may transmit a write request comprising the encrypted data D2 to the communication system 115, i.e., to the memory controller 100. As mentioned previously, the memory controller 100 may then interface with the external memory 50 to handle the write request.

Conversely, in various embodiments, the memory cipher engine circuit 30 may receive a read request via the interface 300. In response to receiving the read request, the memory cipher engine circuit 30 may transmit a read request to the communication system 115, i.e., to the memory controller 100. In response to the read request, the memory controller obtains the respective encrypted data D2 from the external memory 50 and transmits the encrypted data D2 to the master interface 302. Once the response data comprising the encrypted data D2 is received, the memory cipher engine circuit 30 generates decrypted data D1 by decrypting the data D2, and generates the response to the read request received via the interface 300, where the response comprises the decrypted data D1.

For example, to implement the cryptographic operations, the memory cipher engine circuit 30 may comprise a cryptographic processing circuit 306, such as an AES (Advanced Encryption Standard) processing circuit, and one or more registers 308 providing configuration data to the cryptographic processing circuit 306. For example, the registers 308 may be configured to store one or more cryptographic keys, and may optionally be used to set an encryption mode. In various embodiments, the cryptographic processing circuit 306 may be configured to operate in Counter (CTR) mode.

In various embodiments, the memory cipher engine circuit 30 may comprise an interface 310, which permits programming of the configuration data stored in the registers 308. For example, in various embodiments, the interface, such as a peripheral bridge, may be connected to the communication system 114, whereby the registers 308 may be associated with a respective physical address range of the communication system 114. In this case, the processing core 102 may program the registers by sending write requests comprising the respective physical address to the communication system 114. In various embodiments, the processing system 10a is configured to inhibit read operations received from the processing core 102, in particular at least to the registers 308 used to store the cryptographic key(s).

Additionally or alternatively, the registers 308 may be programmed during a configuration phase of the processing system 10a. For example, in various embodiments, the processing system 10a may comprise a configuration circuit 310 configured to read configuration data from a non-volatile memory 104c and write the configuration data to the registers 308. In various embodiments, the non-volatile memory 104c used to store the configuration data is integrated in the processing system 10a. In this case, a debug interface may be used to program the configuration data stored in the non-volatile memory 104c.

In various embodiments, the registers 308 may be used to configure one or more address ranges used to specify a protected address range or an unprotected address range. For example, in this case, in response to receiving a request via the slave interface 300, the memory cipher engine circuit 30 may determine whether the physical address included in the request (or the respective memory address of the memory controller 100 associated with the physical address) is included in a protected address range specified via the configuration data stored in the registers 308. Accordingly, in response to determining that the address is included in a protected address range, the memory cipher engine circuit 30 may enable the cryptographic operation, i.e., encrypt the data D2 transmitted to the memory controller 100 and decrypt the data D2 received from the memory controller 100. Conversely, in response to determining that the address is not included in a protected address range, the memory cipher engine circuit 30 may disable the cryptographic operation, i.e., forward the data D1 received via the interface 300 with a write request as data D2 to the memory controller 100 and transmit via the interface 300 the data D2 received via the interface 302 as data D1.

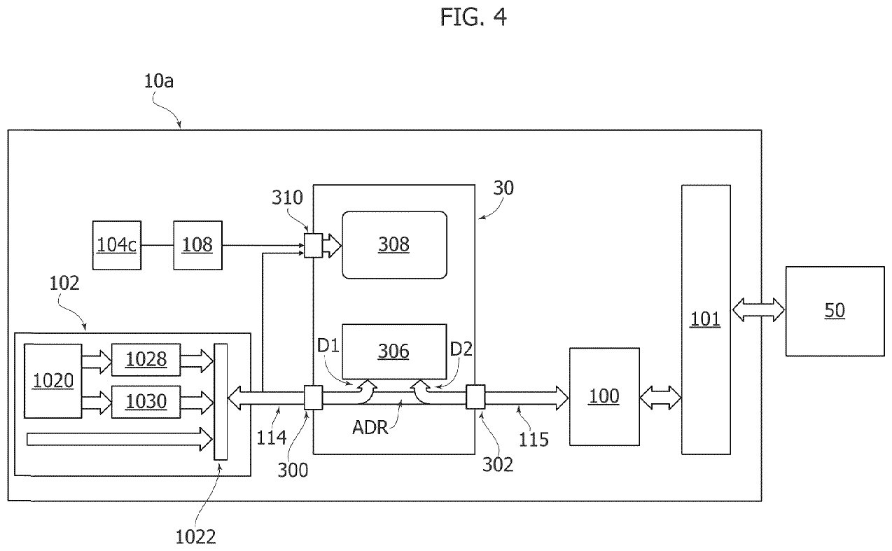

FIGS. 5A and 5B illustrate the operation of a cryptographic processing circuit 306 using counter mode. Specifically, FIG. 5A shows an encryption operation, and FIG. 5B shows a decryption operation.

In both cases, data CTR is provided as input to a block-cipher encryption circuit 3060, such as an AES processing circuit, which generates encrypted data CTR_ENC as a function of the data CTR and a cryptographic key CK. In a typical block-cipher encryption algorithm with counter mode, the data CTR corresponds to a count value, and the data CTR_ENC corresponds to an encrypted counter.

As shown in FIG. 5A, during encryption, the encrypted data DATA_ENC is generated by combining plain data DATA with the encrypted data CTR_ENC via an XOR operation 3062. Conversely, as shown in FIG. 5B, during decryption, the decrypted data DATA is generated by combining the encrypted data DATA_ENC again with the same encrypted data CTR_ENC via the XOR operation 3062.

For example, in the context of AES, the data CTR, K, CTR_ENC, DATA, and DATA_ENC often have 16 bytes, i.e., 128 bits. This implies that up to 16 bytes of data DATA may be encrypted with the same data CTR_ENC.

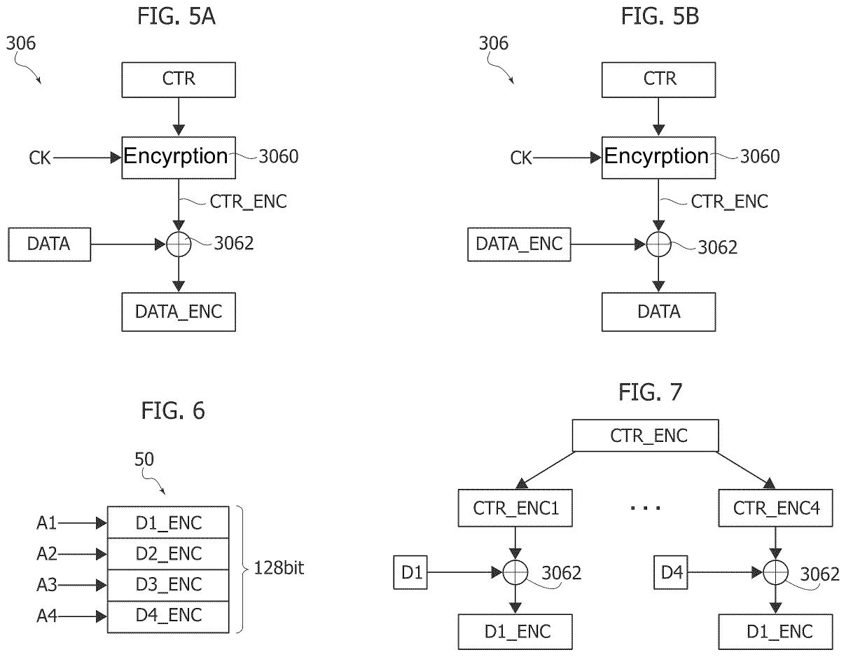

FIG. 6 shows an example of 16 bytes of encrypted data stored in memory 50. In the embodiment considered, each memory location is adapted to store a word of data, i.e., 4 bytes/32 bits. For example, FIG. 6 shows four words of data D1_ENC, D2_ENC, D3_ENC, and D4_ENC, which are stored at four consecutive memory addresses A1, A2, A3, and A4.

With the memory organization shown in FIG. 6, a given data CTR_ENC may be associated with each memory area of 16 bytes, and the same data CTR_ENC may be used to generate the encrypted data D1_ENC, D2_ENC, D3_ENC, and D4_ENC to be stored at memory addresses A1, A2, A3, and A4.

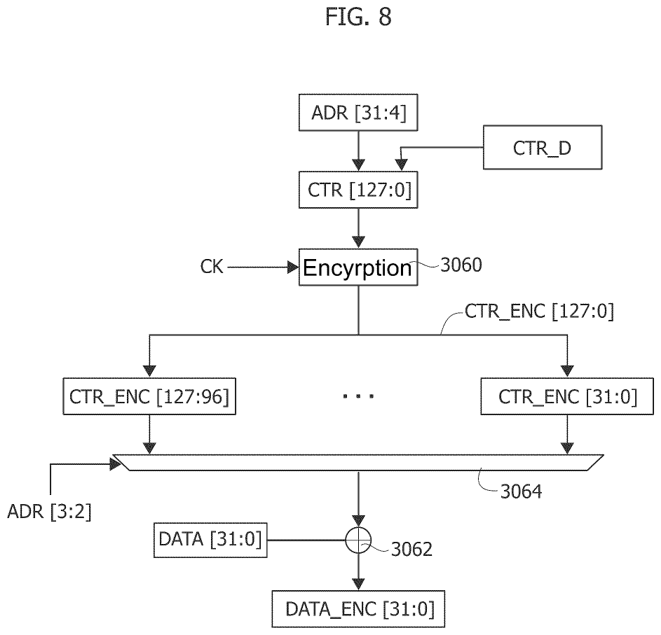

As shown in FIG. 7, the 16 bytes of data CTR_ENC may be split into four packets CTR_ENC1 to CTR_ENC4, each comprising 4 bytes of the data CTR_ENC. For example, CTR_ENC1 may correspond to the data CTR_ENC[127:96], CTR_ENC2 may correspond to the data CTR_ENC[95:64], CTR_ENC3 may correspond to the data CTR_ENC[63:32] and CTR_ENC4 may correspond to the data CTR_ENC[31:0], Next, the data D1_ENC are generated by combining the data D1 with the data CTR_ENC1, the data D2_ENC are generated by combining the data D2 with the data CTR_ENC2, the data D3_ENC are generated by combining the data D3 with the data CTR_ENC3 and the data D4_ENC are generated by combining the data D4 with the data CTR_ENC4. The XOR operation applied to a given bit is independent from the other XOR operations.

However, a typical communication system usually does not transmit 16 bytes at once; instead, data is transmitted sequentially. For example, the write request for writing D1_ENC to memory address A1 is transmitted with a first request, and the write request for writing D2_ENC to memory address A2 is transmitted with a second request. Moreover, not all memory locations A1 to A4 may be written; for example, only memory address A1 may be written.

This implies that the data CTR_ENC must be recalculated each time an access is performed to a different memory area of 16 bytes/128 bits. In this respect, addresses used by AHB bus systems assign a unique address to each byte. For example, when organizing memory 50 as sequential blocks of 16 bytes/128 bits, the address A1 will have the last four bits A1[3:0] set to “0000”, the address A2 will have the last four bits A2[3:0] set to “0100”, the address A3 will have the last four bits A3[3:0] set to “1000”, and the address A4 will have the last four bits A4[3:0] set to “1100”.

Thus, in various embodiments, to obtain the value CTR_ENC, it is sufficient to determine whether the remaining most significant bits of the address signal ADR have changed.

A similar operation may also be performed when memory 50 has memory locations with a different number of bits, or when the block-cipher algorithm operates with a different number of bits, such as 256 or 512 bits. For example, when each memory location has 2 bytes, the 16 bytes of memory area may correspond to data D1_ENC to D8_ENC, each having 16 bits. In this case, the data CTR_ENC is split into eight packets CTR_ENC1 to CTR_ENC8, each having 16 bits/2 bytes. In general, assuming a block-cipher using K bytes and memory locations having N bytes, the data CTR_ENC may be split into K/N packets, with each packet used for the data to be stored at a respective memory location/address.

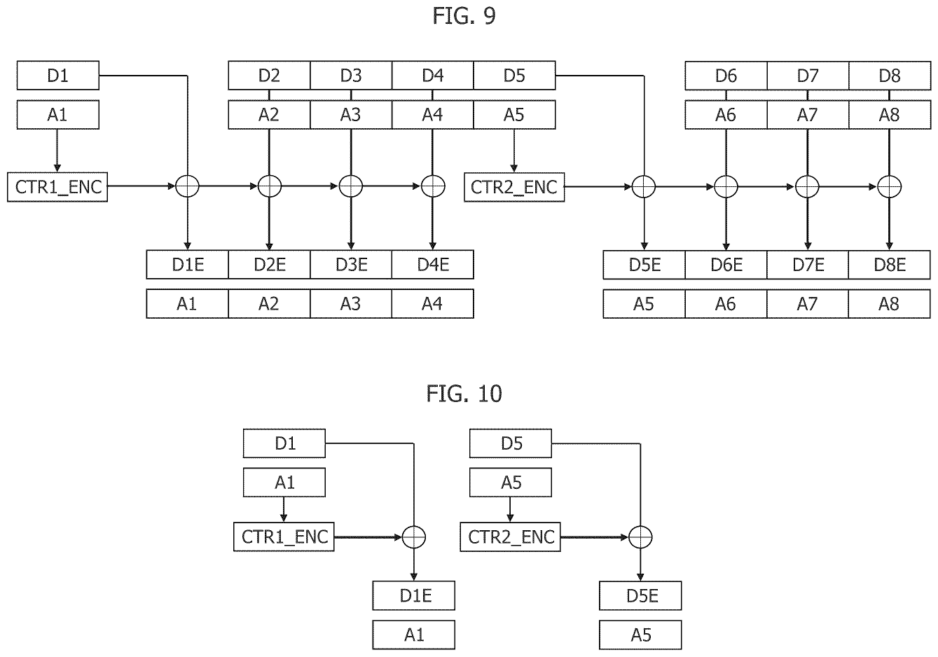

As shown in FIG. 8, the cryptographic processing circuit 306 may receive an address ADR and data DATA. In the embodiment considered, both signals have 32 bits. Thus, the cryptographic processing circuit 306 may determine whether the bits ADR[31:4] have changed. Conversely, in case the signal ADR has 16 bits, the cryptographic processing circuit 306 may determine whether the bits ADR[15:4] has changed. The address signal ADR may also have more or fewer bits, and it is sufficient to disregard the 4 least significant bits of the address signal ADR, which address the specific byte of the 16-byte address block. Thus, in various embodiments, the number L of least significant bits corresponds to log 2K, e.g., 4 bits for 16 bytes. However, in a communication system where addresses A1 to A4 are consecutive, the number L of least significant bits may correspond to log₂(K/N), e.g., 2 bits for K/N=4 memory locations.

Accordingly, in response to determining that the remaining bits, e.g., indicated as ADR[N*8-1:L](e.g., ADR[31:4] or ADR[15:4]) have changed, the cryptographic processing circuit 306 may obtain the respective data CTR and generate the data CTR_ENC via the block-cipher encryption circuit 3060. For example, in various embodiments, in order to associate with each memory area of K (e.g., 16) bytes respective data CTR_ENC, the data CTR are determined as a function of the bits ADR[N*8-1:L](e.g., ADR[31:4] or ADR[15:4]). For example, in various embodiments, the data CTR correspond to the data ADR[31:4](or ADR[15:4]) and additional data CTR_D, which e.g., may be programmable. The data CTR_ENC will also be identified as encrypted address in the following, even though the data CTR may also comprise additional data CTR_D. Conversely, in response to determining that the bits ADR[N*8-1:L](e.g., ADR[31:4] or ADR[15:4]) have not changed, the previously calculated encrypted address CTR_ENC is still valid.

As mentioned previously, in various embodiments, based on the number of bytes N of the data signal DATA, the data CTR_ENC is split into K/N packets. For example, if DATA has 4 bytes, CTR_ENC is split into four packets CTR_ENC1 to CTR_ENC4, each having N bytes.

Specifically, as shown in FIG. 8, the bits of the data CTR_ENC to be used to generate the respective encrypted data DATA_ENC are selected via a multiplexer 3064 as a function of the L least significant bits of the address signal ADR. For example, when using data DATA having N=1 byte (with K=16), one of the respective data CTR_ENC1 to CTR_ENC16 is selected based on the bits ADR[3:0]. Conversely, when using DATA having N=4 bytes, one of the respective data CTR_ENC1 to CTR_ENC4 may selected based on the bits ADR[3:2].

In line with the description of FIG. 5B, the same operations may be performed for decrypting encrypted data DATA_ENC, because CTR_ENC is valid for the complete block of K bytes, both for encryption and decryption.

However, this means that the computation of CTR_ENC may be performed not for each write or read operation, but only when a given read or write request accesses an address ADR of a different memory area of K bytes.

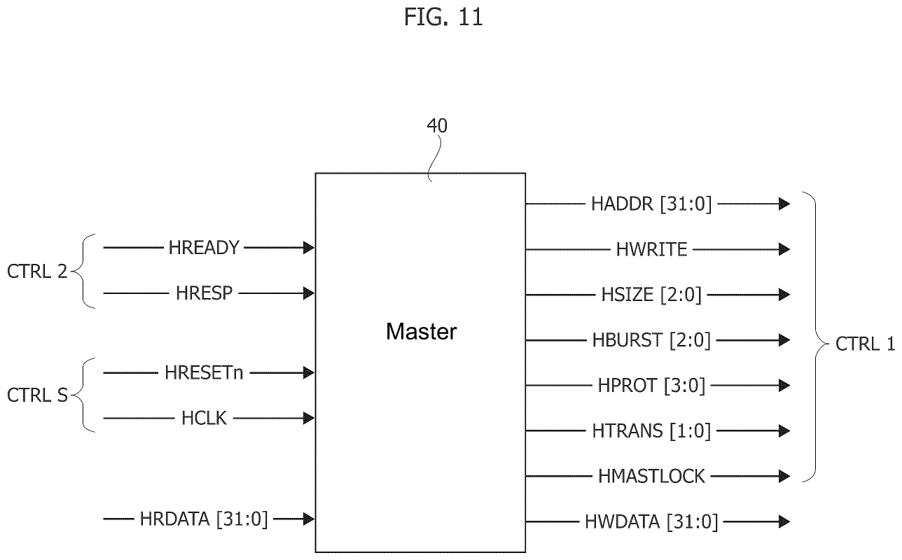

For example, FIG. 9 shows an example, wherein the processing circuit 102 sends a sequence of eight write requests to eight consecutive addresses A1 to A8. Specifically, in the example considered, the data D1 to D4 to be stored to the memory addresses A1 to A4 may be encrypted with the same encrypted data CTR1_ENC, and the data D5 to D8 to be stored to the memory addresses A5 to A8 may be encrypted with the same encrypted data CTR2_ENC. Without loss of generality, it is assumed that the data D1 to D8 have N=4 bytes.

Once the memory cipher engine circuit 30 receives the write request to address A1, it determines the respective data CTR, referred to as CTR1, as a function of address data A1, particularly the most significant bits, e.g., bits A1[31:4] or A1[15; 4]. Next, the memory cipher engine circuit 30 generates the encrypted address CTR_ENC, referred to as CTR1_ENC, by encrypting CTR1 based on key CK. Once CTR1_ENC is obtained, the memory cipher engine circuit 30 calculates encrypted data D1E by combining D1 with the respective bits of the data CTR1_ENC via an XOR operation (see also the description of FIG. 8) and sends a respective write request to the memory controller 100. For example, the memory cipher engine circuit 30 may select respective 32 bits of CTR1_ENC based on the least significant bits of the address A1, e.g., the bits CTR1_ENC[127:96].

Conversely, when receiving the following write requests addressed to the same memory block of K=16 bytes, the memory cipher engine circuit 30 may omit the calculation of the data CTR1_ENC, and use the previously calculated data CTR1_ENC. For example, in response to receiving the write request to the address A2, the memory cipher engine circuit 30 may calculate the encrypted data D2E by combining the data D2 with the respective bits of the data CTR1_ENC via an XOR operation and send a respective write request to the memory controller 100. For example, the memory cipher engine circuit 30 may select respective N bytes of the data CTR1_ENC based on the least significant bits of the address A2, e.g., the bits CTR1_ENC[95:64]. In response to receiving the write request to the address A3, the memory cipher engine circuit 30 may calculate the encrypted data D3E by combining the data D3 with the respective bits of the data CTR1_ENC via an XOR operation and send a respective write request to the memory controller 100. For example, the memory cipher engine circuit 30 may select respective N bytes of the data CTR1_ENC based on the least significant bits of the address A3, e.g., the bits CTR1_ENC[63:32]. Finally, in response to receiving the write request to the address A4, the memory cipher engine circuit 30 may calculate the encrypted data D4E by combining the data D4 with the respective bits of the data CTR1_ENC via an XOR operation and send a respective write request to the memory controller 100. For example, the memory cipher engine circuit 30 may select respective N bytes of the data CTR1_ENC based on the least significant bits of the address A4, e.g., the bits CTR1_ENC[31:0].

Conversely, when receiving the write requests addressed to a different memory block of K bytes, the memory cipher engine circuit 30 has to recalculate the encrypted address CTR_ENC. For example, once the memory cipher engine circuit 30 receives the write request to the address A5, the memory cipher engine circuit 30 may determine the respective data CTR, indicated also as first data CTR2, as a function of the address data A5, in particular the respective most significant bits, e.g., bits A5[31:4] or A5[15:4]. Next, the memory cipher engine circuit 30 generates the encrypted address CTR_ENC, indicated also as first data CTR2_ENC, by encrypting the data CTR2 based on the key CK. Accordingly, once having obtained the data CTR2_ENC, the memory cipher engine circuit 30 may calculate the encrypted data D5E by combining the data D5 with the respective bits of the data CTR2_ENC via an XOR operation and send a respective write request to the memory controller 100. For example, the memory cipher engine circuit 30 may select respective N bytes of the data CTR2_ENC based on the least significant bits of the address A5, e.g., the bits CTR2_ENC[127:96].

Accordingly, when receiving the following write requests addressed to the same memory block of 16 bytes, the memory cipher engine circuit 30 may omit the calculation of the data CTR2_ENC, and use the previously calculated data CTR2_ENC. For example, in response to receiving the write request to the address A6, the memory cipher engine circuit 30 may calculate the encrypted data D6E by combining the data D6 with the respective bits of the data CTR2_ENC via an XOR operation and send a respective write request to the memory controller 100. For example, the memory cipher engine circuit 30 may select respective N bytes of the data CTR2_ENC based on the least significant bits of the address A6, e.g., the bits CTR2_ENC[95:64]. In response to receiving the write request to the address A7, the memory cipher engine circuit 30 may calculate the encrypted data D7E by combining the data D7 with the respective bits of the data CTR2_ENC via an XOR operation and send a respective write request to the memory controller 100. For example, the memory cipher engine circuit 30 may select respective N bytes of the data CTR2_ENC based on the least significant bits of the address A7, e.g., the bits CTR2_ENC[63:32]. Finally, in response to receiving the write request to the address A8, the memory cipher engine circuit 30 may calculate the encrypted data D8E by combining the data D4 with the respective bits of the data CTR2_ENC via an XOR operation and send a respective write request to the memory controller 100. For example, the memory cipher engine circuit 30 may select respective N bytes of the data CTR2_ENC based on the least significant bits of the address A8, e.g., the bits CTR2_ENC[31:0].

The same operations for calculating the encrypted address CTR_ENC are also performed for read operations, i.e., the memory cipher engine circuit 30 calculates the encrypted address CTR_ENC only when a read request to a different memory block ofK bytes is performed.

As shown in FIG. 10, in the worst-case scenario, each read or write request received fromthe processing circuit 102 is addressed to a different memory block of K bytes. For example, FIG. 10 shows the example, wherein a request is addressed to the address A1 of a first memory block, and the immediately following request is addressed to the address A5 of a second memory block.

The operation shown in FIGS. 9 and 10 implies that the timing of read and write requests changes depending on whether the same or a different memory block is accessed. If the same memory block is accessed, it may be sufficient for the memory cipher engine circuit 30 to calculate the respective encrypted data DATA_ENC via combinational logic operations (e.g., multiplexer 3064 and XOR operation 3062). Conversely, in case a different memory block is accessed, the memory cipher engine circuit 30 has to recalculate the encrypted address CTR_ENC, which may require various cycles, also called rounds, wherein each round may involve one or more clock cycles.

For example, this implies that the memory cipher engine circuit 30 cannot simply forward the received read or write request to the memory controller 100 within the same clock cycle; it must suspend communication on bus 114 until CTR_ENC has been computed and the request can be forwarded to the memory controller 114.

The following describes an embodiment of the processing system 10a shown in FIG. 4, where each of the communication systems 114 and 115 is implemented with a system bus, such as an Advanced High-performance Bus (AHB) or an AHB-Lite bus, as disclosed, for example, in the AMBA® 3 AHB-Lite Protocol Specification, v1.0, ARM, which is incorporated herein by reference for this purpose.

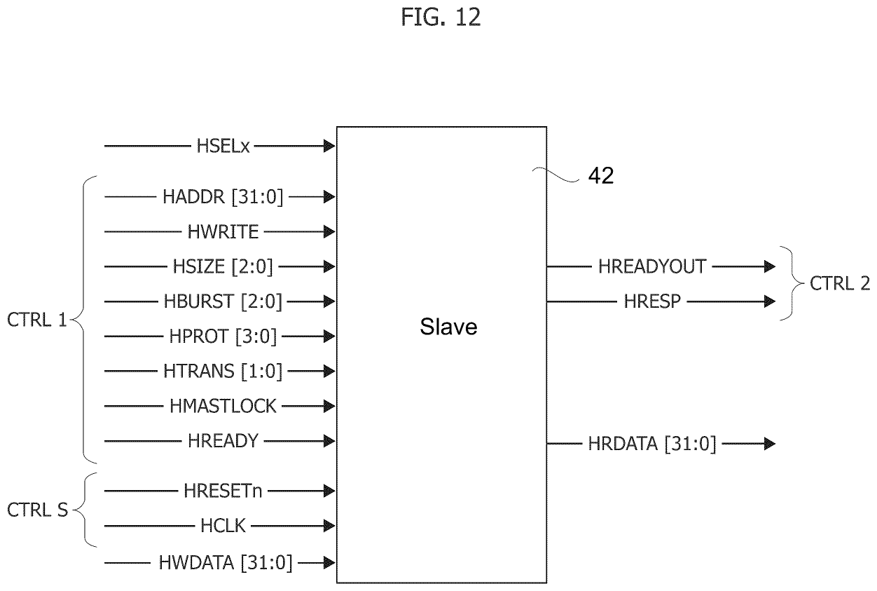

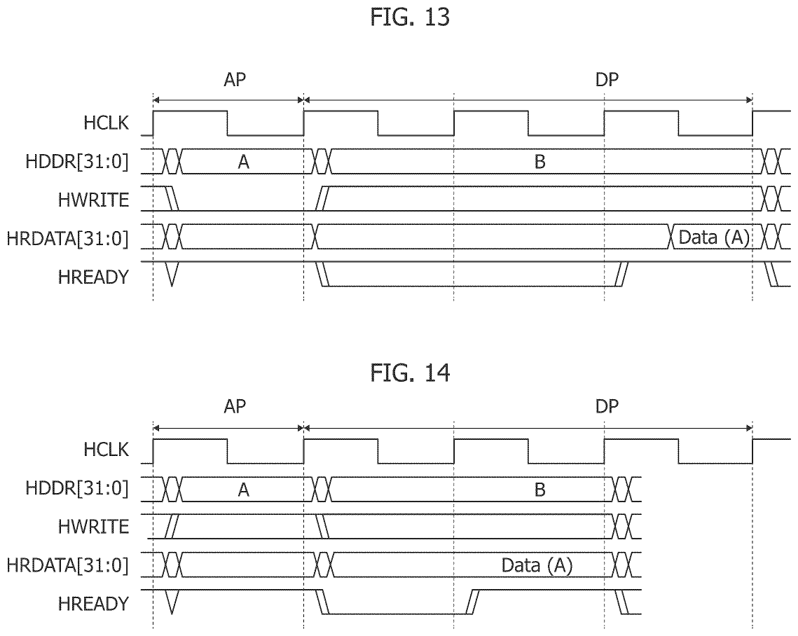

FIGS. 11 and 12 show the signals exchanged between an AHB-Lite master circuit 40 (FIG. 11) and an AHB-Lite slave circuit 42 (FIG. 12). Specifically, both the master circuit 40 and the slave circuit 42 receive system signals CTRLS, including a clock signal HCLK and a reset signal. In various embodiments, each master circuit 40 and each slave circuit 42 may receive a respective reset signal HRESETn. For example, this allows a reset management circuit to selectively reset only a given master or slave circuit, or a subset of master and slave circuits.

In the embodiment considered, the master circuit 40 is configured to signal a read or write request via a set of control signals CTRL1, which may include: a transfer type signal HTRANS [1:0] indicating whether a transfer is requested and optionally the transfer type of the current transfer; an address signal HADDR [31:0] indicating the address of a request; a transfer direction signal HWRITE indicating a write transfer (logic level high) or a read transfer (logic level low); a burst type signal HBURST [2:0] indicating whether the transfer is a single transfer or part of a burst; an optional lock signal HMASTLOCK indicating whether the current transfer is part of a locked sequence; an optional protection control signal HPROT [3:0] providing additional information about a bus access; an optional size signal HSIZE [2:0] indicating the size of the transfer, typically byte, halfword, or word.

Specifically, in the case of AHB or AHB-Lite, the transfer type signal HTRANS [1:0] may indicate IDLE, BUSY, NONSEQUENTIAL, or SEQUENTIAL. The value IDLE is used to indicate that no data transfer is required. The value BUSY enables masters to insert idle cycles in the middle of a burst, indicating that the master is continuing with a burst but the next transfer cannot take place immediately. The value NONSEQUENTIAL indicates a single transfer or the first transfer of a burst. The remaining transfers in a burst are indicated via the value SEQUENTIAL. The burst type signal HBURST may have a value SINGLE indicating a single transfer, or other values associated with various types of burst modes, such as INCR or WRAP.

To indicate a single transfer, the master 40 may set the signals HTRANS and HBURST to NONSEQUENTIAL and SINGLE, respectively. To indicate a burst mode, the master 40 may set the signals HTRANS to NONSEQUENTIAL and a burst mode value (e.g., INCR) for the first transmission of the burst, and then set the signal HTRANS to SEQUENTIAL for subsequent transmissions.

For a write request, the master circuit 40 also generates a data signal HWDATA with N bytes, for example, 32 bits HWDATA [31:0], corresponding to the data to be transferred from the master 40 to the slave 42. For example, the number N may be hardwired or set via the signal HZISE. Accordingly, in various embodiments, the slave circuit 42 receives the control signals CTRL1 and the data signal HWDATA.

In many bus configurations, such as a conventional AHB-Lite configuration, various slave devices are connected to the master circuit 42 via a decoder (not shown in the figures) configured to generate for each slave circuit 42 a respective slave selection signal HSELx.

To handle the request, the selected slave circuit 42 generates the following control signals CTRL2 for managing the request: a ready signal HREADYOUT used to indicate that the transfer is complete; and a transfer response signal HRRESP indicating whether the transfer was successful (logic level low) or unsuccessful (logic level high).

For a read request, the selected slave circuit 42 also generates a data signal HRDATA, for example, 32 bits HRDATA [31:0], corresponding to the response data to be transferred from the slave to the master.

One or more multiplexers (not shown in the figures) are usually used to generate signals HRDATA, HRESP, and HREADY by selecting the signals HRDATA, HRESP, and HREADYOUT provided by the selected slave circuit 42. As shown in FIG. 12, the slave circuit 42 also receives the signal HREADY, and for this reason, HREADYOUT refers to the signal generated by the respective slave circuit 42, while HREADY refers to the common signal fed to the master circuit 40 and the slave circuits 42.

Accordingly, in various embodiments, the master circuit 40 receives the signals HREADY, HRESP, and HRDATA.

When using just a single slave device 42, the decoder and multiplexer may be omitted, and the signals HRDATA, HRESP, and HREADY may directly correspond to the signals HRDATA, HRESP, and HREADYOUT provided by the slave device 42.

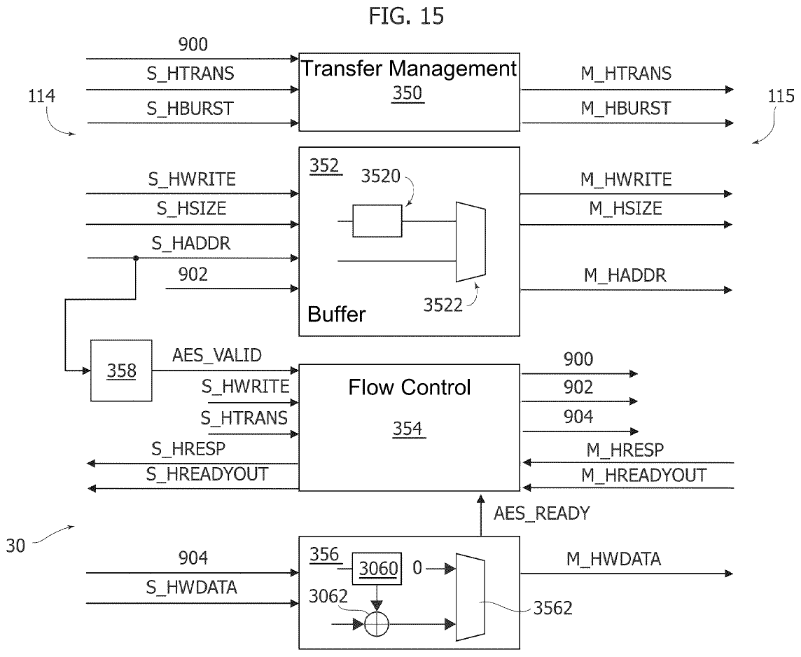

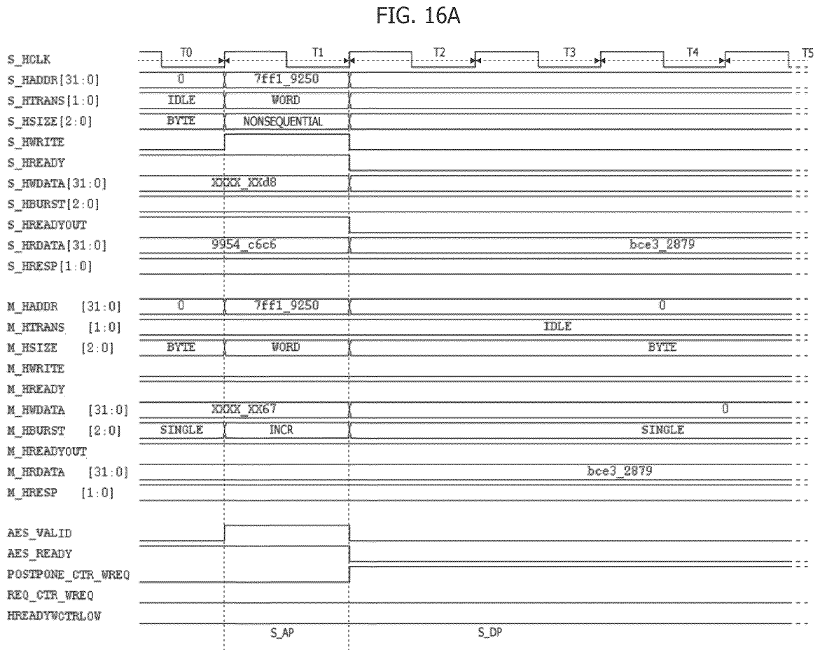

FIGS. 13 and 14 show examples of typical read requests (FIG. 13) and write requests (FIG. 14). In general, an AHB-Lite transfer consists of two phases: an address phase (AP), which lasts for a single clock cycle of the clock signal HCLK unless extended by the previous bus transfer, and a data transfer phase (DP), which might require several clock cycles of the clock signal HCLK.

During the address phase AP, the master circuit 40 sets the address signal HADDR and controls the signal HWRITE to indicate the direction of the data transfer (high for write, low for read). Usually, the master circuit 40 drives the address signal HADDR and the control signals CTRL1 in response to a rising edge of the clock signal HCLK, and a slave circuit 42 then samples the address HADDR and the control information CTRL1 on the next rising edge of the clock signal HCLK. Accordingly, after the slave circuit 42 has sampled the address HADDR and control signals CTRL1, it can assert the signal HREADYOUT (or directly HREADY) and set the appropriate response HRESP, and optionally the data HRDATA (in case of a read request). In response to the signal HREADY, the master 40 may sample the response HRESP and optionally HRDATA on the next clock signal HCLK. Accordingly, the signal HREADY may be used by the slave device 42 to signal that several clock cycles are required to complete the request, i.e., the signal HREADY may be used to delay the response. In this case, the address phase AP of the following request is extended, as shown for a first address phase A and a second address phase B.

In the embodiment shown in FIG. 4, the processing core 102 may be a master device 40 of communication system 114, and interface 300 may be a slave device 42 of communication system 114. Conversely, interface 302 may be a master device 40 of communication system 115, and memory controller 100 may be a slave device of communication system 115.

In this way, the memory cipher engine 30 may receive via slave interface 300 a write request from the processing core 102 or another master device 40 of communication system 114. Next, the memory cipher engine 30 encrypts the data. To this end, the memory cipher engine 30 may comprise one or more registers 308, which can be used for securely storing encryption keys CK and for configuring the cipher engine 30, for example, for setting encryption modes or defining memory regions to be encrypted. The memory cipher engine 30 further comprises an encryption/decryption module 306, which can be configured to carry out encryption or decryption operations with one or more given keys stored in registers 308, for example, using a block-cipher such as Advanced Encryption Standard (AES). Once the data is encrypted, the master interface 302 may send a write request comprising the encrypted data to the memory controller 100.

When using two communication systems 114 and 115, the memory cipher engine 30 should ensure that communication system 114 is maintained in standby while a request is executed. In various embodiments, the slave interface 300 of the memory cipher engine 30 is arranged to de-assert the ready signal HREADYOUT until the read or write request has been executed. In this respect, the memory cipher engine 30 must also manage the computation of the encrypted address CTR_ENC when the address signal HADDR indicates a different memory block of 16 bytes.

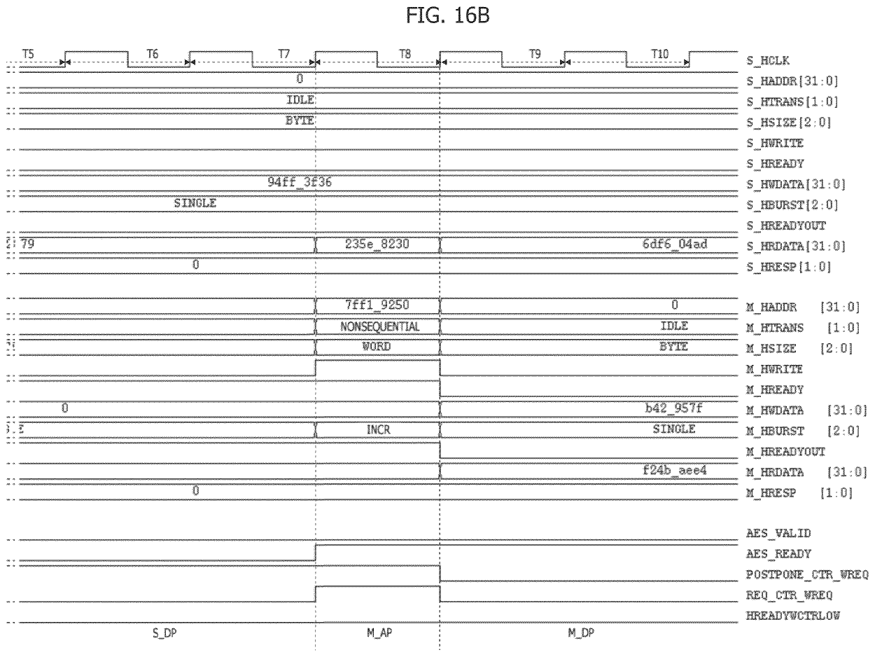

FIG. 15 illustrates another embodiment of a memory cipher engine circuit 30, where the processing core 102 acts as an AHB master 40 and the memory controller 100 acts as an AHB slave 42. Specifically, FIG. 15 highlights the signals exchanged between the processing core 102, the memory controller 100, and the memory cipher engine 30.

In general, although not illustrated, the processing core 102, the memory cipher engine 30, and the memory controller 100 operate under the control of a clock signal HCLK, which provides the correct timing for all bus transfers. In various embodiments, the clock signal HCLK can be an AHB bus clock signal.

In the embodiment considered, the processing core 102 or a similar master device 40 is connected to the memory cipher engine 30 via a first bus 114, and the memory cipher engine 30 is connected to the memory controller 100 via a second bus 115. Accordingly, the memory cipher engine 30 receives from the processing core 102 the address signal HADDR, the control signals CTRL1 for signaling the properties of the request, and a write data signal HWDATA (for a write request). To distinguish the signals between bus 114 and bus 115, signals exchanged via the slave interface of the memory cipher engine 30 are identified with the prefix “S_” (e.g., S_HADDR, S_DWDATA, etc., while signals exchanged via the master interface of the memory cipher engine 30 are identified with the prefix “M_”.

In this embodiment, the address signal S_HADDR received from the processing core 102 is provided to an address comparison circuit 358. The address comparison circuit 358 is configured to assert a signal AES_VALID in response to determining that the address S_HADDR points to a different memory area of K bytes (see also the description of FIG. 9). For example, the address comparison circuit 358 may comprise a register for storing a previous address value. Upon receiving a request, the address comparison circuit 358 compares S_HADDR with the content of the register, particularly the most significant bits, e.g., by masking the L (e.g., 4) least significant bits. If S_HADDR points to a different memory area of K bytes than the stored address, the address comparison circuit 358 stores S_HADDR and asserts AES_VALID. Thus, AES_VALID indicates whether recalculation of the encrypted address CTR_ENC is required.

In this embodiment, the signal S_HWRITE received from the processing core 102 and the signals S_HTRANS and AES_VALID are provided to a flow control circuit 354. The flow control circuit 354 is configured to generate various flow control signals 900, 902, and 904. Additionally, the flow control circuit 354 receives the signals HRESP and HREADY from the memory controller 100, indicated as M_HRESP and M_HREADY, and provides signals HRESP and HREADYOUT to the processing core 102, indicated as S_HRESP and S_HREADYOUT.

The flow control signals 900 are provided to a transfer management circuit 350. The transfer management circuit 350 is configured to receive the transfer type signal H_TRANS and the burst type signal HBURST from the processing core 102, indicated as S_HTRANS and S_HBURST. As described in greater detail below, in various embodiments, the transfer management circuit 350 manages both single write transfers and burst mode write transfers.

Accordingly, the transfer management circuit 350 provides signals HTRANS and HBURST to the memory controller 100, indicated as M_HTRANS and M_HBURST.

The flow control signals 902 are provided to a buffer circuit 352. In various embodiments, the buffer circuit 352 also receives the address signal S_HADDR, the transfer direction signal S_HWRITE, and optional further control signals, such as the signal HSIZE provided by the processing core 102, indicated as signal S_HSIZE.

Finally, the flow control signals 904 are provided to an encryption management circuit 356. The encryption management circuit 356 also receives the data signal HWDATA from the processing core 102, indicated as signal S_HWDATA, and provides a data signal HWDATA to the memory controller 100, indicated as signal M_HWDATA. In various embodiments, the encryption management circuit 356 comprises the circuit shown in FIG. 8.

The following describes a possible operation of the memory cipher engine 30.

Specifically, in response to receiving a write request as signaled via S_HWRITE and S_HTRANS, the flow control circuit 354 determines whether AES_VALID is asserted or de-asserted. As mentioned previously, AES_VALID indicates whether S_HADDR points to a different memory area of K bytes.

If AES_VALID is de-asserted, i.e., the address S_HADDR does not point to a different memory area of K bytes, the encryption management circuit 356, particularly the block-cipher encryption circuit 3060, does not need to calculate the encrypted address CTR_ENC. In this case, the memory cipher engine circuit 30 generates the data M_HWDATA to be provided to the memory controller 100 by combining S_HWDATA with the encrypted address CTR_ENC via logic XOR operation 3062 (see also FIG. 8, where S_HWDATA corresponds to DATA and M_HWDATA corresponds to encrypted DATA_ENC). Thus, the memory cipher engine circuit 30 may simply forward the write request to the memory controller, while replacing (on the fly) data S_HWDATA with the respective encrypted data, i.e., the data M_HWDATA correspond to the encrypted version of the data S_HWDATA, which are generated via the XOR combinational logic operation. For example, the XOR gates 3062 may generate the encrypted data M_HWDATA by combining the data S_HWDATA and the respective portion of the encrypted address CTR_ENC, e.g., selected as a function of the L least significant bits of the address S_HADDR (see also the description of FIG. 8, where the data S_HADDR correspond to the address data ADR). Accordingly, in various embodiments, in this case, the flow-control circuit 354 sets the flow-control signals 900, 902 and 904, such that: the transfer management circuit 350 sets M_HTRANS and M_HBURST to the values of S_HTRANS and S_HBURST, respectively; the buffer circuit 352 sets M_ADDR, M_HWRITE, and optionally M_SIZE to the values of S_ADDR, S_HWRITE, and optionally S_HSIZE, respectively; and the encryption management circuit 356 sets M_HWDATA to the encrypted DATA_ENC.

Thus, the memory cipher engine 30 directly passes/forwards the write request to the memory controller 100, with the encrypted data DATA_ENC. Specifically, with respect to the operation shown in FIG. 14, the processing system 102 transmits the write request with the respective address data S_HADDR during the address phase AP. During the address phase AP, the memory cipher engine 30 is able to set the value of AES_VALID. Next, if AES_VALID is de-asserted, the memory cipher engine 30 sets M_HWDATA in the data phase DP to the encrypted DATA_ENC calculated as a function of S_HWDATA and CTR_ENC.

In this case, the memory cipher engine 30 also directly passes/forwards the response data received from the memory controller 100 to the processing circuit 102, i.e., the flow control circuit 354 sets S_HRESP and S_HREADYOUT to M_HRESP and M_HREADYOUT (or M_HREADY), respectively, thereby directly forwarding the response to the processing circuit 102.

A similar operation may be used for a read request, because a read request may be directly passed to the memory controller 100, with the response data S_HRDATA calculated on the fly based on M_HRDATA and CTR_ENC.

If AES_VALID is asserted, the address S_HADDR is associated with a different memory area of 16 bytes. This implies that the encryption management circuit 356, in particular the block-cipher encryption circuit 3060, has to calculate the encrypted address CTR_ENC based on the address S_HADDR and the flow-control circuit 354 has to delay the transmission of the write request until the data have been encrypted.

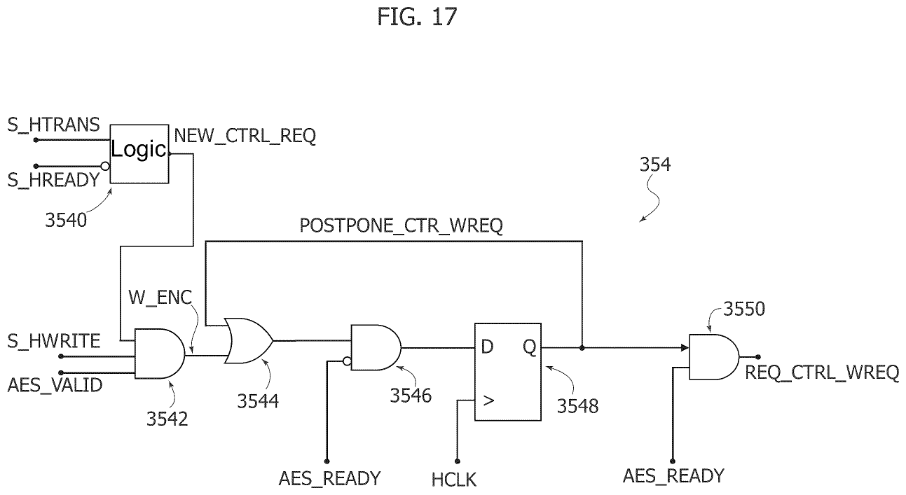

The following describes, with reference to FIGS. 16A and 16B, the handling of a single write request. As shown in FIG. 16A, during an address phase S_AP (e.g., corresponding to clock cycle T1), the processing core 102 applies an address S_HADDR (e.g., set to 0x7ff1 9250) and sets the signal S_HTRANS to NONSEQUENTIAL. The processing core 102 also sets S_HBURST to SINGLE, indicating a single write request.

In this embodiment, when it is determined that S_HADDR indicates a different memory area of K bytes, the address comparison circuit 358 asserts AES_VALID during the address phase S_AP.

In this case, the memory cipher engine circuit 30 recalculates the encrypted address CTR_ENC, suspends the write operation on bus 114, and waits until CTR_ENC has been calculated before forwarding the write request to the memory controller 100 via bus 115.

For example, in various embodiments, when AES_VALID is asserted, the flow control circuit 354 de-asserts S_HREADYOUT with the next clock cycle, indicating that the write request cannot be processed immediately. Thus, the processing core 102 starts the next clock cycle (e.g., T2) with the respective data phase S_DP and waits until S_HREADY is asserted by the memory cipher engine 30 (via S_HREADYOUT).

Additionally, the flow control circuit 354 drives (via signals 900) the transfer management circuit 350 to set M_HTRANS to IDLE, indicating that no request is transmitted to the memory controller 100. In various embodiments, the transfer management circuit 350 may also set M_HBURST to a predetermined value, such as INCR.

Since the request is in the idle state (M_HTRANS=IDLE), the other signals provided to the memory controller 100 may have any value. For example, in FIGS. 16A and 16B, the flow control circuit 354 drives the buffer circuit 352 so that M_HADDR and M_HSIZE correspond to S_HADDR and S_HSIZE, respectively. The flow control circuit 354 also drives (via signals 904) the encryption management circuit 356 so that M_HWDATA is set to a given value, which may be a default value such as 0x0000 0000. In this way, the memory cipher engine 30 avoids providing unencrypted data S_HWDATA to the memory controller 100.

Additionally, in this embodiment, the flow control circuit 354 drives (via signals 902) the buffer circuit 352 to store the values of S_HADDR, S_WRITE, and optionally S_HSIZE.

Meanwhile, the encryption management circuit 356 enables the block-cipher encryption circuit 3060, whereby the block-cipher encryption circuit 3060 calculates the encrypted value CTR_ENC as a function of the address S_HADDR and the key CK.

Optionally, the encryption management circuit 356, in particular the block-cipher encryption circuit 3060, may also receive the signal AES_VALID and process the data CTR in response to determining that the signal AES_VALID is asserted. Next, once having completed the computation of the encrypted address CTR_ENC, the cryptographic circuit 306 asserts a signal AES_READY, thereby indicating that the data CTR_ENC are valid. Moreover, once the data CTR_ENC have been computed, the encryption management circuit 356 generates the data M_HWDATA by combining the data S_HWDATA with the encrypted address CTR_ENC via logic XOR operation 3062 (see also the description of FIG. 8, where the data S_HWDATA correspond to the data DATA and the data M_HWDATA correspond to the encrypted data DATA_ENC).

In this embodiment, AES_READY is provided to the flow control circuit 354.

When AES_READY is asserted (e.g., in clock cycle T8), the flow control circuit 354 sets signals 900, 902, and 904 to signal the write request to the memory controller 100. During an address phase M_AP, the flow control circuit 354 sets signals 900, 902, and 904 so that: the transfer management circuit 350 sets M_HTRANS to NONSEQUENTIAL and optionally M_HBURST to a predetermined value, such as INCR; the buffer circuit 352 applies the previously stored values to S_HADDR, S_HWRITE, and optionally S_HSIZE (e.g., S_HADDR is set to 0x7ff1 9250 and S_HWRITE is asserted).

Thus, the memory cipher engine circuit 30 receives, during address phase S_AP, a single write request to a different memory area of K bytes and suspends the request by de-asserting S_HREADYOUT.

While the next cycle starts the data phase S_DP, the processing circuit 102 suspends operation because the signal S_HREADYOUT is de-asserted. Once the new data CTR_ENC has been computed, the memory cipher engine circuit 30 generates a write request, which is transmitted to the memory controller 100. Specifically, the memory cipher engine circuit 30 generates a single write request during address phase M_AP.

With the next clock cycle (e.g., T9), the flow control circuit 354 starts the respective data phase M_DP. During the data phase, the flow control circuit 354 sets signals 900, 902, and 904 so that: the encryption management circuit 356 provides M_HWDATA as the encrypted DATA_ENC calculated as a function of S_HWDATA and CTR_ENC (e.g., 0x0b42 957f); the transmission management circuit sets M_HTRANS to the value of S_HTRANS (which in the example is IDLE), indicating that the communication is completed or that a new request is transmitted; the buffer circuit 352 provides M_HADDR, M_HWRITE, and optionally M_HSIZE as the respective received signals S_HADDR, S_HWRITE, and S_HSIZE, indicating a possible new request.

Accordingly, once having determined that the write request has been executed, e.g., in response to determining that the signal M_HREADYOUT/M_HREADY is asserted, the memory cipher engine circuit 30 has also to assert the signal S_HREADYOUT. For example, this is also shown in FIG. 16B, wherein the memory controller 100, once having received during the address phase M_AP the write request, de-asserts the signal M_HREADYOUT/M_HREADY. For example, this is usually the case, when the memory 50 is a non-volatile memory or when a serial communication protocol is used for the communication between the memory controller 100 and the memory 50.

Although not shown in FIGS. 16A and 16B, in this embodiment, the flow control circuit 354 waits until M_READY is asserted. When M_READY is asserted, the flow control circuit 354 asserts S_HREADYOUT and provides S_HRESP as the value of M_HRESP.

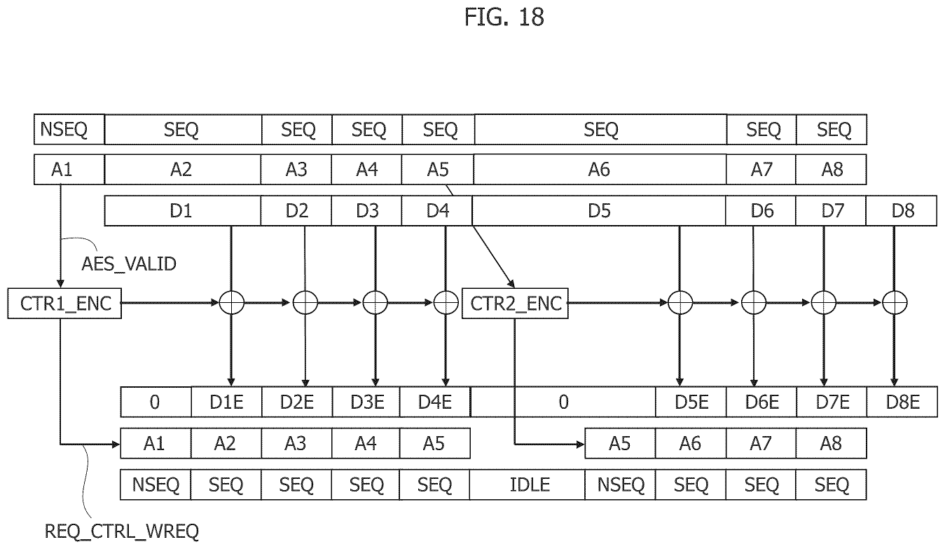

FIG. 17 shows a possible embodiment of the flow control circuit 354. In this embodiment, the flow control circuit 354 includes a circuit configured to detect a read or write request. Specifically, in an AHB or AHB-Lite bus, a new request is signaled when: the signal HTRANS is set to the value NONSEQUENTIAL; or the signal HTRANS is set to the value SEQEUNTIAL and the signal HREADY is asserted.

The first case applies to a single transmission or the first transmission of a burst mode.

The second case applies to subsequent communications of a burst mode, which will be described in greater detail below. In this embodiment, the flow control circuit 354 includes a combinational logic circuit 3540 configured to assert a signal NEW_CTR_REQ in response to determining that the signal S_HTRANS is set to the value NONSEQUENTIAL, or the signal S_HTRANS is set to the value SEQEUNTIAL and the signal S_HREADY is asserted.

In various embodiments, instead of using the signal S_HREADY, the circuit 3540 may also receive the signal S_HREADYOUT generated by the flow-control circuit 354.

Additionally, the flow control circuit 354 includes a logic gate 3542, such as an AND gate, configured to assert a signal W_ENC in response to NEW_CTR_REQ being asserted, S_HWRITE being asserted, and AES_VALID being asserted. The signal W_ENC thus indicates a write request to a different memory area of 16 bytes, requiring recalculation of CTR_ENC.

If AES_VALID or W_ENC is de-asserted, the memory cipher engine circuit 30 may directly forward the write request to the memory controller 100, with the encryption management circuit 356 calculating M_HWDATA by combining S_HWDATA with CTR_ENC via an XOR operation. This case is not treated specifically in the following.

Conversely, in case the signal W_ENC is asserted, the flow control circuit 354 has to delay the write request. For this purpose, the memory cipher engine circuit 30 may mask the write request received from the processing circuit 102, e.g., by setting via the circuit 350 the signal M_HTRAN to IDLE, and optionally the signal M_HBRUST to INCR, e.g., in response to the signal AES_VALID or W_ENC, which may be part of the signals 900. Moreover, the memory cipher engine circuit 30 stores the values of the signals S_HADDR, and optionally the signals S_HWRITE, S_HSIZE. For example, the circuit 352 may store these signals, e.g., in response to the signal AES_VALID or W_ENC, which may be part of the signals 902.

When AES_VALID is asserted, the encryption management circuit 356 determines the new CTR as a function of S_HADDR and generates the new encrypted address CTR_ENC as a function of CTR. AES_VALID may be part of signals 904. The encryption management circuit 356 also calculates M_HWDATA by combining S_HWDATA with CTR_ENC via an XOR operation.

For example, in various embodiments, in response to AES_VALID, the encryption management circuit 356 de-asserts AES_READY and starts the encryption operation. Once CTR_ENC has been computed, the encryption management circuit 356 asserts AES_READY.

In this case, the flow control circuit 354 should wait until AES_READY is asserted again.

In this embodiment, when W_ENC is asserted, the flow control circuit 354 asserts POSTPONE_CTR_WREQ. Thus, the flow control circuit 354 asserts this signal when a write request to a different memory area of 16 bytes is received. Conversely, the flow control circuit 354 de-asserts POSTPONE_CTR_WREQ once the cryptographic circuit 306 signals that the new CTR_ENC has been generated, for example, in response to AES_READY.

For example, in various embodiments, the flow control circuit 354 comprises a set-reset flip flop, wherein the signal W_ENC is connected to the set input of the flip-flop, the signal AES_READY is connected to the reset input, and the flip-flop provides the signal POSTPONE_CTR_REQ.

Conversely, FIG. 17 shows an embodiment, wherein the flow control circuit 354 comprises a d-type flip flop 3548 providing at output the signal POSTPONE_CTR_WREQ.

In this case, the signal W_ENC and POSTPONE_CTR_REQ may be provided to an OR gate 3544, wherein the output signal of the OR gate 3544 and the inverted version of the signal AES_READY are provided to an AND gate 3546, wherein the output signal of the AND gate 3546 is connected to the (data) input of the flip-flop 3548.

Accordingly, in the embodiment considered, the signal AES_READY is used as a synchronous reset signal for the signal POSTPONE_CTR_WREQ, i.e., the signal POSTPONE_CTR_WREQ is de-asserted at the next rising edge of the clock signal HCLK compared to the signal AES_READY. For example, this is also shown in FIG. 16B.

Accordingly, in order to signal the address phase M_AP, the flow control circuit 354 may generate a signal REQ_CTRL_WREQ, which e.g. is asserted when the signal AES_READY is asserted and the signal POSTPONE_CTR_REQ is asserted. For example, for this purpose, the flow control circuit 354 may comprise an AND gate 3550 receiving at input the signals AES_READY and POSTPONE_CTR_REQ and providing at output the signal REQ_CTRL_WREQ.

In response to REQ_CTRL_WREQ, the memory cipher engine circuit 30 generates the write request. For example, in various embodiments, in response to REQ_CTRL_WREQ (which may be part of signals 900 and 902), circuit 350 sets M_HTRANS to NONSEQUENTIAL and optionally M_HBURST to INCR (or a previously stored value of S_HBURST), and circuit 352 provides the previously stored values for M_HADDR, M_HSIZE, and M_HWRITE. Since the request is a write request, S_HWRITE may also be asserted, as M_HWRITE indicates a write request.

This phase thus corresponds to the address phase M_AP of bus 115. When REQ_CTRL_WREQ is de-asserted in the next clock cycle (due to reset via AES_READY), the encrypted DATA_ENC is applied to M_HWDATA, corresponding to the data phase M_DP of bus 115.

Also, in this case, the response signals M_HREADYOUT (or M_HREADY) and M_HRESP are forwarded to the processing circuit 102 as S_HREADYOUT and S_HRESP, respectively.

In various embodiments, the flow control circuit 354 is configured to de-assert S_HREADYOUT in response to AES_READY being de-asserted. Conversely, when AES_READY is asserted, the flow control circuit 354 provides M_HREADY (or M_HREADYOUT). However, this does not account for the situation in phase M_AP (interval T8), where AES_READY is asserted while M_HREADY is still asserted. To detect this condition, S_HREADYOUT may also be de-asserted when REQ_CTR_WREQ and M_HREADY (or M_HREADYOUT) are both asserted.

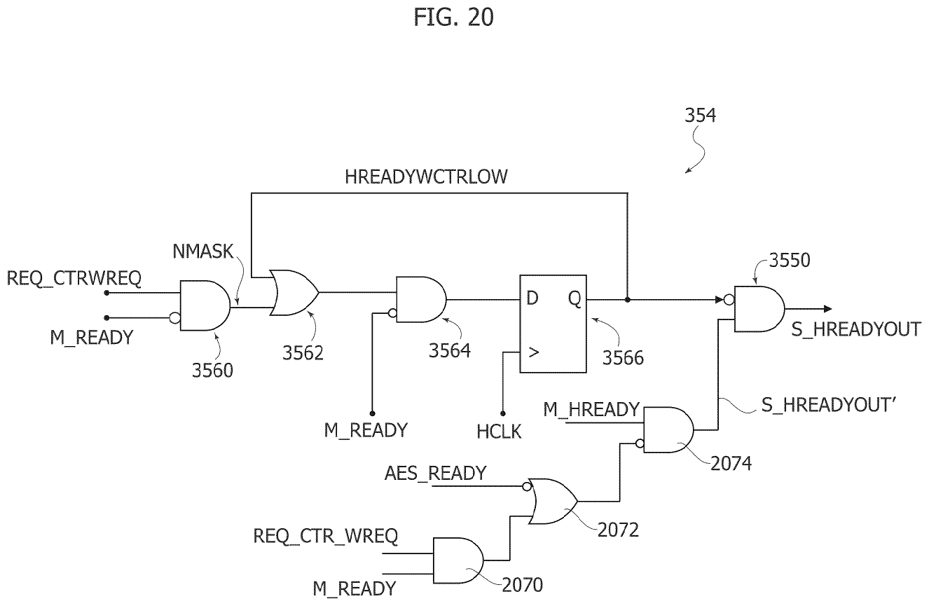

For example, FIG. 20 shows a portion of the flow control circuit 354 configured to generate a signal S_HREADYOUT′, which is then used to generate the final signal S_HREADYOUT as described in greater detail below.

In this embodiment, REQ_CTR_WREQ and M_HREADY (or M_HREADYOUT) are provided to an AND gate 2070, signaling the situation at time T8 of FIG. 16B. The output of AND gate 2070 and the inverted AES_READY are provided to an OR gate 2072, also signaling the time intervals T2 to T7 when AES_READY is low. The output of OR gate 2072 may be used to mask M_HREADY (or M_HREADYOUT). In this embodiment, the inverted output of OR gate 2072 and M_HREADY (or M_HREADYOUT) are provided to an AND gate 2074, which generates S_HREADYOUT′. Thus, S_HREADYOUT′ is de-asserted when AES_READY is low, or when REQ_CTR_WREQ and M_HREADY (or M_HREADYOUT) are asserted.

This operation works correctly for single write requests, i.e., when S_HTRANS is set to NONSEQUENTIAL and S_HBURST is set to SINGLE. When AES_VALID is de-asserted, the memory cipher engine circuit 30 directly forwards the single write request, using encrypted DATA_ENC for M_HWDATA. When AES_VALID is asserted, the memory cipher engine circuit 30 inhibits forwarding of the request during address phase S_AP and, once AES_READY is asserted (i.e., once CTR_ENC has been computed), generates a new request during address phase M_AP by setting M_HTRANS to NONSEQUENTIAL. The memory cipher engine circuit 30 may set M_HBURST during address phase M_AP to the value of S_HBURST during address phase S_AP (e.g., SINGLE), or may use INCR (as described in greater detail below).

Moreover, this operation works for the first transmission of a burst mode. A burst mode is signaled via a first transmission where S_HTRANS is set to NONSEQUENTIAL and S_HBURST is set to INCR or another burst mode type.

Thus, the first transmission of a burst mode may be handled exactly as a single write request. For this reason, the memory cipher engine circuit 30 may set M_HTRANS to NONSEQUENTIAL during address phase M_AP, which is valid for both single write requests and the first transmission of a burst mode, and M_HBURST may correspond to a stored value of S_HBURST (e.g., SINGLE for a single write request or INCR for the first transmission of a burst mode), or the value INCR (which may also be used for a single write request).

Finally, the described operation also works for burst mode transmissions that do not access a different memory area of K bytes. In this case, the write request may be directly forwarded to the memory controller 100.

However, the described flow control circuit 354 cannot correctly handle a subsequent write request in burst mode when this request accesses a different memory area of K bytes. In burst mode, S_HREADYOUT/S_HREADY is used to switch to the next address applied to S_HADDR and the next data S_HWDATA (valid for the previous address). Thus, the memory cipher engine circuit 30 cannot simply suspend the write operation.

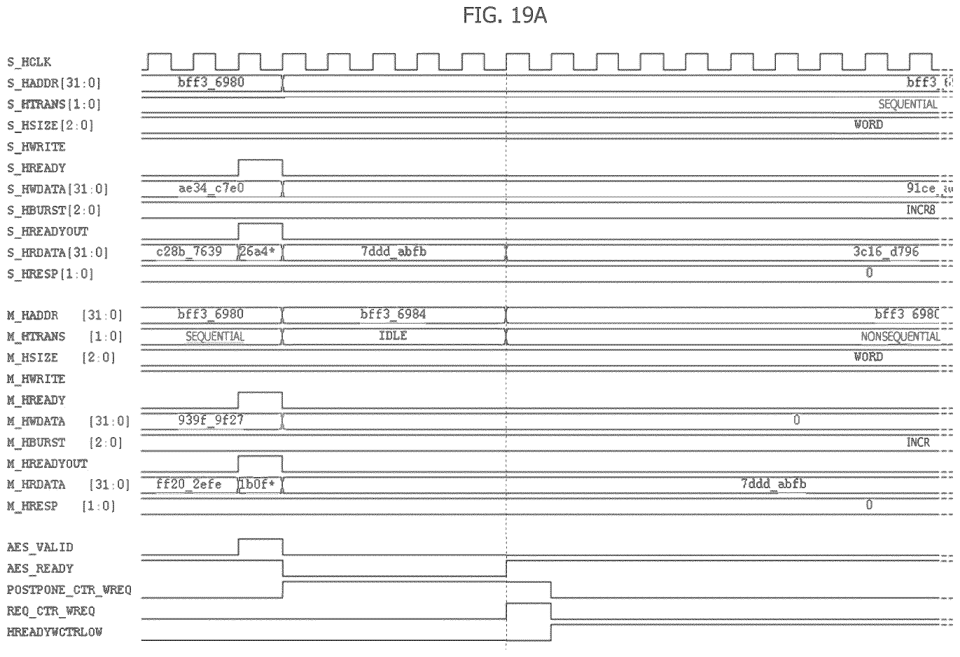

FIG. 18 shows an embodiment of the operation of the memory cipher engine circuit 30 in case of a burst mode transmission. In the example considered, the burst mode writes in sequence data D1 to D8 to respective memory locations A1 to A8, wherein the addresses A1 and A8 point to new memory areas of 16 bytes.

Specifically, according to the burst mode, the processing circuit 102 signals first during an address phase the write request, i.e., via the signals S_HTRANS, S_HBURST, S_HWRITE, S_HADDR. Specifically, in case of a burst mode, the first transmission is signaled via a signal S_HTRANS set to NONSEQUENTIAL, indicated in FIG. 18 with “NSEQ”. Accordingly, in the example considered, the processing circuit 102 provides the address A1 during this phase. Moreover, with the next clock cycle of the signal HCLK, the processing circuit 102 provides the respective data D1 via the signal S_HWDATA.

Accordingly, in the embodiment considered, the memory cipher engine circuit 30 determines that the address signal S_HADDR, i.e., the address A1, points to a new memory area of 16 bytes and asserts the signal AES_VALID. In response to this signal, the memory cipher engine circuit 30 calculates the respective encrypted address CTR_ENC as a function of the address signal S_HADDR, while masking the least significant bits.

As described in the foregoing, the memory cipher engine circuit 30 waits until the calculation of the encrypted address CTR_ENC has been completed, and then signals the respective write request to the memory controller 100. For example, as also described with respect to FIG. 16B, in response to determining that the signal REQ_CTRL_WREQ is asserted, the memory cipher engine circuit 30 sets at least the signal S_HADDR to the address A1 and the signal S_HTRANS to NONSEQUENTIAL. Preferably, during this phase, the signal S_HWDATA is set to a predetermined value, e.g., OxO. Moreover, with the next clock cycle the memory cipher engine circuit 30 provides the respective encrypted data DiE (determined as a function of the data D1 and the encrypted address CTR_ENC) as signal S_HWDATA.

Accordingly, once the memory controller 100 has completed the write operation, the memory controller 100 asserts the signal M_HWREADYOUT/M_HWREADY, which the memory cipher engine circuit 30 forwards to the processing circuit 102 via the signal S_HWREADYOUT.

Specifically, according to the burst mode, while providing the data D1, the processing circuit 102 already signals the second transmission via the signals S_HTRANS, S_HBURST, S_HWRITE, S_HADDR. Specifically, in case of a burst mode, the second transmission is signaled via a signal S_HTRANS set to SEQUENTIAL, indicated in FIG. 18 with “SEQ”. Accordingly, in the example considered, the processing circuit 102 provides the address A2 during this phase.

However, since the signal AES_VALID is de-asserted, the memory cipher engine circuit 30 directly forwards the request to the memory controller 100. In fact, while transmitting the data DiE, the memory cipher engine circuit 30 signals a SEQUENTIAL transmission to the address A2.

Accordingly, once the processing circuit 102 detects that the signal S_HWREADYOUT is asserted, the processing circuit 102 provides the data D2 signals, while already signaling a further SEQUENTIAL transmission to the address A3.

Specifically, since the data CTR_ENC are still valid, the memory cipher engine circuit 30 may provide the respective encrypted data D2E, while already signaling the further SEQUENTIAL transmission to the address A3. The same operation is repeated also for the data D3 and address A4, whereby the memory cipher engine circuit 30 provides the respective encrypted data D3E, while already signaling the further SEQUENTIAL transmission to the address A4.

Accordingly, once the memory controller 100 asserts the signal M_HREADYOUT/M_HREADY, the memory cipher engine circuit 30 also asserts the signal S_HREADYOUT. In response to this signal, the processing circuit 102 signals the next SEQUENTIAL transmission to the address A5, while providing the data D4.

Specifically, in this case, the memory cipher engine circuit 30 sets the signal M_HWDATA to the respective encrypted value D4E, while signaling already the next request to the address A5.

Thus, once the memory controller 100 asserts the signal M_HREADYOUT/M_HREADY, which is forwarded to the processing circuit 102, the processing circuit 102. In response to the respective signal S_HREADY, the processing circuit provides the data D5, while already signaling the next request to the address A6.

However, due to the fact that the address A5 point to a different memory area of 16 bytes, the data CTR_ENC are not valid and the signal AES_VALID is asserted. For this reason, the memory cipher engine circuit 30 applies a predetermined value to the signal M_HWDATA. However, according to the AHB specification, the memory controller 100 considers these data as valid data associated with the write request to the address A5, i.e., the memory controller 100 stores the predetermined data to the address A5.

Accordingly, in order to overcome this problem, in various embodiments, the memory cipher engine circuit 30 interrupts the communication with the memory controller by setting the signal M_HTRANS to IDLE. Moreover, the memory cipher engine circuit 30 waits until the memory controller 100 signals the completion of the write request via the signal M_HREADYOUT/M_HREADY. In response to determining that the signal M_HREADYOUT/M_HREADY is asserted, the memory cipher engine circuit 30 generates a new write request by setting the signal M_HWADDR to the address A5 and the signal M_HTRANS to NONSEQUENTIAL, and provides in the next clock cycle the respective encrypted data DSE. In fact, in the meantime the memory cipher engine circuit 30 calculates the new encrypted address CTR_ENC, which are then used to compute the data D5E as a function of the data D5 and CTR_ENC. Furthermore, according to the AHB specification, data D5E as well as the predetermined value corresponding to address A5, are stable during the transfer to the memory controller, (i.e. data phase), in compliance with AHB3-lite rule IHI0033A: “For write operation the master holds the data stable throughout the extended cycles”.

Thus, in the embodiment considered, the memory cipher engine circuit 30 interrupts the burst mode communication with the memory controller 100 by performing a “dummy” write operation of predetermined data to the first memory location associated with a different memory area of 16 bytes, and then starting a new burst mode communication with the memory controller 100 for writing the encrypted data associated with this memory location.

Conversely, the following transmissions of the data D6, D7 and D8 may be handled again in a transparent manner, because the data CTR_ENC remain valid.

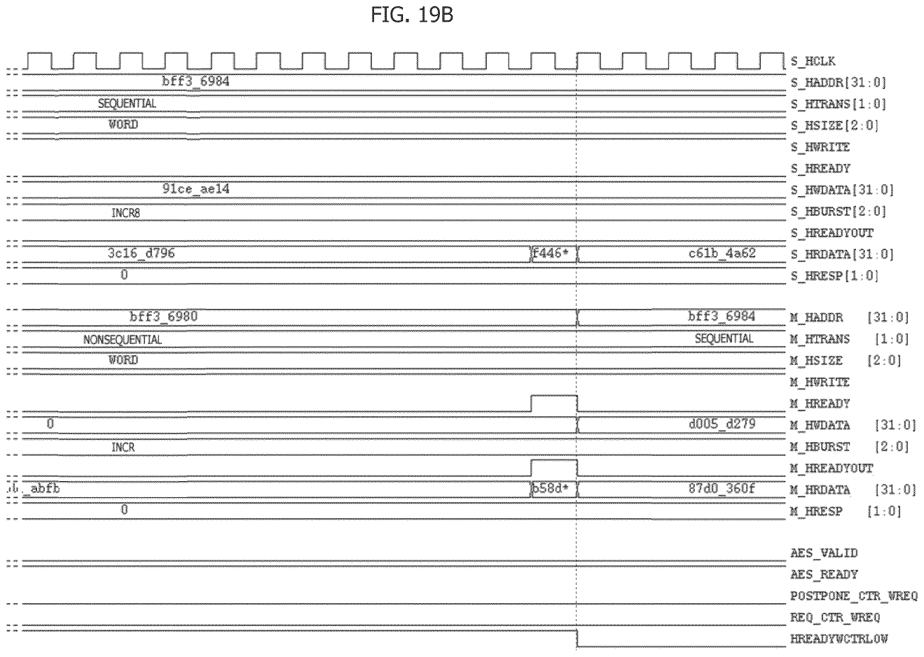

Specifically, FIGS. 19A and 19B show the transmission of the burst mode when the address S_HADDR points to a different memory area of K bytes Specifically, in the example considered, the address 0xbff3 6980 (e.g., corresponding to the address A5) is applied to the address S_HADDR, while the signal S_HTRANS is set to SEQUENTIAL, thereby already signaling the write request to the address 0xbff3 6980, while data associated with a previous address (e.g., A4) are applied to the signal S_HWDATA, e.g., 0xae34 c7e0.

In response to the signal M_HREADYOUT, the memory cipher engine circuit 30 also asserts the signal S_HREADYOUT. In response to this signal, the processing circuit 102 provides the data associated with the address 0xbff3 6980 (e.g., A5), while already signaling a further write request to a next address. For example, in FIGS. 19A and 19B, the data (e.g. D5) correspond to 0x9ice ae14, and the next address (e.g., A6) corresponds to 0xbff3 6983.

However, since the memory cipher engine circuit 30 determines that the address 0xbff3 6980 points to a different memory area of K bytes, the memory cipher engine circuit 30 asserts the signal AES_VALID. In response to the signal AES_VALID, the memory cipher engine circuit 30 asserts the signal REQ_CTR_WREQ as described in the foregoing, while also applying the predetermined constant value, e.g., 0, with the aim to hide the engine output to the external world, to the signal M_HWDATA, and setting the signal M_HTRANS to IDLE, thereby interrupting the burst communication with the memory controller 100.

These signals trigger two parallel operations. On the one hand, the memory cipher engine circuit 30 determines the new data CTR (as a function of the address 0xbff3 6980) and computes the new encrypted address CTR_ENC. In various embodiments, the end of this operation is signaled via the signal AES_READY. On the other hand, the memory controller 100 starts the write operation of the predetermined value, e.g., 0, to the previous address value 0xbff3 6980 (e.g., A5). The end of this operation is signaled via the signal M_HREADY/M_HREADYOUT.

In various embodiments, the memory cipher engine circuit 30 is thus configured to wait that the signals AES_READY and M_HREADY/M_HREADYOUT are asserted, and then signals a new write request. However, in various embodiments, the calculation of the encrypted address CTR_ENC is faster than the write operation to the external memory. In this case, the memory cipher engine circuit 30 may be configured to signal a new write request already once the new data CTR_ENC have been computed, e.g., in response to the signal AES_READY. For example, this is shown in FIG. 19A. Specifically, in response to determining that the signal AES_READY is asserted, the memory cipher engine circuit 30 applies the previously stored address 0xbff3 6980 to the signal M_HADDR, and sets the signals M_HTRANS and M_HBURST to NONSEQUENTIAL and INCR, respectively, thereby signaling a first transmission of a new burst of undetermined length.

Next, the memory cipher engine circuit 30 waits until the memory controller 100 signals the completion of the write request of the predetermined value, e.g., 0. Specifically, as shown in FIG. 19B, in response do determining that the signal M_HREADY/M_HREADYOUT is asserted, the memory cipher engine circuit 30 provides the encrypted data associated with the address 0xbff3 6980, e.g., 0xd005 d279, which have been calculated based on the new encrypted address CTR_ENC.

As described in the foregoing, in this case, the memory cipher engine circuit 30 may then signal a next transmission received from the processing circuit 102, e.g., by setting the address M_HADDR to 0xbff3 6984 and the signal M_HTRANS to SEQUENTIAL.

In this respect, the inventors have observed that this pulse in the signal M_HREADY/M_HREADYOUT should not be propagated to the processing circuit 102. In fact, the memory cipher engine circuit 30 just interrupts the burst communication with the memory controller 100, while the communication with the processing circuit is still pending. Accordingly, by propagating the pulse to the signal S_HREADYOUT, the processing circuit 102 would already skip to the next transmission, while the memory cipher engine circuit 30 is still repeating the write operation, this time with the encrypted data.

Accordingly, in various embodiments, in response to determining that the situation shown in FIG. 18 occurs, the memory cipher engine circuit 30 is configured to mask the propagation of the signal M_HREADY/M_HREADYOUT.

For example, FIG. 20 shows possible implementation of the part of the flow-control circuit 354 implementing the generation of the signal S_HREADYOUT.

Specifically, as described in the foregoing, the signal S_HREADYOUT corresponds to the signal S_HREADYOUT′ in case of a first write request or a write request when the data CTR_ENC remain valid. Accordingly, an additional circuit is required to generate the (final) signal S_HREADYOUT by masking the signal S_HREADYOUT′ when the previously described situation occurs.

Specifically, in the embodiment considered, the flow-control circuit 354 is configured to generate a signal indicating that the burst mode should be interrupted because the data CTR_ENC have to be recalculated. In various embodiments, the completion of the re-calculation of the encrypted address CTR_ENC is signaled via the signal REQ_CTR_WREQ.

In this respect, as shown in FIG. 16A, in case of a single transmission or a first transmission of a burst mode, the signal M_HREADY/M_HREADYOUT is asserted when the signal REQ_CTR_WREQ is asserted. Conversely, as shown in FIG. 19A, in case of a further transmission of a burst mode, the signal M_HREADY/M_HREADYOUT is de-asserted when the signal REQ_CTR_WREQ is asserted. Accordingly, in various embodiments, the flow-control circuit 354 comprises an AND gate 3560 receiving at input the signal REQ_CTR_WREQ and the inverted version of the signal M_HREADY (or M_HREADYOUT), thus generating at output a signal NMASK indicating whether the next pulse in the signal S_HREADYOUT should be masked.

In various embodiments, the flow-control circuit 354 is thus configured to assert a signal HREADYWCTRLOW in response to determining that the signal NMASK, and de-assert the signal HREADYWCTRLOW in response to the next pulse in the signal M_HREADYOUT, e.g., in response to determining that the signal M_HREADYOUT is asserted. However, also other signals may be used to generate the signal HREADYWCTRLOW or a similar signal.

For example, in the embodiment considered, the flow-control circuit 354 comprises a d-type flip flop 3566, and OR gate 3562 and an AND gate 3564. Specifically, the OR gate receives at input the signal at the output of the flip-flop 3566, which corresponds to the signal HREADYWCTRLOW, and the signal NMASK at the output of the AND gate 3560. The AND gate 3564 receives at input the signal at the output of the OR gate 3562 and the inverted version of the signal M_HREADY (or M_HREADYOUT), and the output of the AND gate 3564 is connected to the (data) input of the flip-flop 3566. Accordingly, when the signal NMASK is asserted, the flow-control circuit 354 asserts the signal HREADYWCTRLOW.

Moreover, when the signal M_HREADY (or M_HREADYOUT) is asserted, the flow-control circuit 354 de-asserts the signal HREADYWCTRLOW with the next clock cycle of the signal HCLK.

Accordingly, in the embodiment considered, when the signal HREADYWCTRLOW is de-asserted, the signal S_HREADYOUT should correspond to the signal S_HREADYOUT′. Conversely, when the signal HREADYWCTRLOW is asserted, the signal S_HREADYOUT should be de-asserted.

For example, for this purpose, the flow control circuit 354 may comprise an AND gate 3568 configured to generate the signal S_HREADYOUT by combining the inverted version of signal HREADYWCTRLOW with the signal S_HREADYOUT′.

For example, the flow control circuit 354 shown in FIGS. 17 and 20 may be modelled with the following VHDL code:
S_HREADYOUT<=
‘0’ when (REQ_CTR_WREQ=‘1’ and M_HREADYOUT=‘1’) or HREADYCTRLOW=‘1’ else
M_HREADYOUT and AES_READY

In fact, the flow-control circuit 354 is configured to de-assert the signal S_HREADYOUT in response to determining that the signal AES_READY is de-asserted, the signal REQ_CTR_WREQ and M_HREADYOUT are asserted, or the signal HREADYCTRLOW is asserted. Otherwise, the signal S_HREADYOUT corresponds to the signal M_HREADY (or M_HREADYOUT).

The signals shown in FIGS. 17 and 20 may be used to generate the flow control signals 900, 902 and 904 discussed with respect to FIG. 9. For example, as described before, the encryption management circuit 356 is configured to selectively provide: the encrypted data DATA_ENC; a predetermine value, e.g., 0x0, in order to avoid attacks and implement the dummy write operation.

Accordingly, in various embodiment, the encryption management circuit 356 may set the signal M_HWDATA by default to the signal DATA_ENC generated as a function of the data S_HWDATA and the encrypted address CTR_ENC. However, in response to determining that the signal POSTPONE_CTR_REQ (indicating that an encryption operation is running) is asserted or the signal HREADYWCTRLOW is asserted (indicating that the burst request has to be reprocessed), the encryption management circuit 356 may provide as signal M_HWDATA the predetermined value.

For example, in FIG. 9 this is schematically shown via a multiplexer 3562 receiving at input the data signal DATA_ENC provided by the XOR gates 3062, and the predetermined value, e.g., 0x0.

For example, this part of the encryption management circuit 356 may be modelled with the following VHDL code:
M_HWDATA <=
(others=>‘0’) when POSTPONE_CTR_REQ=‘1’ or HREADYWCTRLOW=‘1’ else
CTR_ENC x or S_HWDATA;

In various embodiments, the buffer circuit 352 is configured to selectively store the received data S_HADDR and optionally S_HWRITE and/or S_HSIZE in response to given events. The stored signals will be indicated also as signals S_HADDR_CTR, S_HWRITE_CTR and S_HSIZE_CTR. For example, in various embodiments, the buffer circuit 352 is configured to store the data in response to detecting that the signal W_ENC is asserted, i.e., in response to detecting a write request to a different memory area of K bytes.

Moreover, the buffer circuit 352 is configured to selectively provide: by default the received data S_HADDR, S_HWRITE and optionally S_HSIZE (transparent mode); in response to determining that the signal REQ_CTR_WREQ or the signal HREADYWCTRLOW is asserted, the stored address S_HADDR_CTR, and optionally the stored data S_HWRITE_CTR and/or S_HSIZE_CTR.

For example, this is schematically shown a buffer circuit 3520 comprising a register 3520, preferably implemented with latches, arranged to store the received signals S_HADDR and optionally S_HWRITE and/or S_HSIZE in response to the flow control signals 902, e.g., the signal W_ENC or NEW_CTR_REQ, and a multiplexer configured to provide the received signals S_HADDR and optionally S_HWRITE and/or S_HSIZE or the stored signals S_HADDR_CTR and optionally S_HWRITE_CTR and/or S_HSIZE_CTR as a function of the flow control signals 902, e.g., the signal ENC_AP.

For example, this part of the buffer circuit 352 may be modelled with the following VHDL code:
M_HADDR <=
S_HADDR_CTR when REQ_CTR_WREQ=‘1’ else
S_HADDR;
M_HWRITE <=‘1’ when REQ_CTR_WREQ=‘1’ else S_HWRITE;
M_HSIZE <=S_HSIZE_CTR when REQ_CTR_WREQ=‘1’ else S_HSIZE;

Thus, in the embodiment considered, the signal M_HWRITE is asserted and not set to the possibly stored value S_HWRITE_CTR, because it is implicit that the signal REQ_CTR_WREQ signals a write request.

Finally, the transfer management circuit 350 is configured to provide: by default the signals S_HTRANS and S_HBURST; set the signal M_HTRANS to the value NONSEQUENTIAL and S_HBURST to INCR when the signal REQ_CTRL_WREQ or, e.g., the signal HREADYWCTRLOW is asserted; and set the signal M_HTRANS to the value IDLE in order to interrupt the burst transmission, e.g., when the signal WENC is asserted or, while the signal REQ_CTRL_WREQ is de-asserted, the signal POSTPONE_CTR_WREQ is asserted (see also FIG. 19A).

For example, this the generating of the signal M_HTRAN may be modelled with the following VHDL code:
M_HTRANS <=
k_trn_idle when W_ENC=‘1’ else
k_trn_nonseq when REQ_CTR_WREQ=‘1’ else
k_trn_idle when POSTPONE_CTR_WREQ=‘1’ else
S_HTRANS;
where k_trn_idle has the bit value for IDLE and k_trn_nonseq has the bit value for NONSEQUENTIAL.

In various embodiments, as shown in FIGS. 19A and 19B, each of the signals M_HTRANS, M_HADDR, M_HWRITE and M_HSIZE described in the foregoing may indeed be provided to respective retention/hold circuit (not shown in the figures), wherein each retention/hold circuit is configured to: when the signal M_HREADY is asserted, provide the respective signal as described in the foregoing; when the signal M_HREADY is de-asserted, proceed to the storing when the value of the respective signal M_HTRANS, M_HADDR, M_HWRITE and M_HSIZE changes, or the signal REQ_CTR_WREQ is asserted (in order to provide the respective stored value), afterwards propagating the buffered values until M_HREADY is asserted again.

Accordingly, the solutions described in the foregoing, provide low complexity solutions for interfacing a standard microprocessor with a standard memory controller, while implementing an additional encryption operation for the data to be stored to an external memory.

Various embodiments and variants have been described. Those skilled in the art will understand that certain features of these embodiments can be combined and other variants. In particular, for example, in various embodiments, the block-cipher encryption circuit 3060 may operate with a different number of bits, such as 32 of 64 bytes. This implies that the data CTR_ENC may apply to a respective larger memory area, e.g., having 32 or 64. Accordingly, in this case, the address comparison circuit 358 may mask more least significant bits, while the multiplexer 3064 may receive more least significant bits, for each the number of least significant bits may correspond to 5 for 32 bytes and 6 for 64 bytes.

Finally, the practical implementation of the embodiments and variants described herein is within the capabilities of those skilled in the art based on the functional description provided hereinabove while falling within the scope of the invention as defined in the attached claims.

1. A processing system, comprising:
a processing circuit;
a memory controller configured to interface a memory, wherein each memory slot of said memory has a given number N of bytes;
a memory cipher engine circuit comprising a slave interface connected via a first communication system to the processing circuit and a master interface connected via a second communication system to said memory controller, wherein said first and second communication systems communicate a write request by transmitting in an address phase first and second address signals, respectively, and first and second control signals, respectively, indicating a write request, and in a following data phase first and second data signals, respectively, indicating the data associated with the write request, wherein said first and second communication systems comprise first and second ready signals, respectively, indicating completion of a write request;
wherein said memory cipher engine circuit comprises a block cipher cryptographic circuit configured to generate an encrypted address having a given number K of bytes, wherein each encrypted address is associated with a given memory area of K bytes in said memory, and wherein said block cipher cryptographic circuit is configured to:
receive an encryption-request signal and an address signal indicating a given memory area of K bytes in said memory,
in response to determining that said encryption-request signal is asserted, compute the encrypted address as a function said address signal, and
once having completed the computation of said encrypted address, assert an encryption-ready signal;
wherein said memory cipher engine circuit is configured to:
receive from said processing circuit via said first address signal and said first control signal a write request to a first address;
in response to receiving said write request to said first address:
determine address data indicating a memory area of K bytes in said memory comprising said first address,
store said address data,
deassert said first ready signal provided to said processing circuit and set said second data signal to a given value,
provide said address data to said block cipher cryptographic circuit, and assert said encryption-request signal,
wait until said encryption-ready signal is asserted,
in response to determining that said encryption-ready signal is asserted, set said second address signal and said second control signal to indicate a write request to said first address and, in a following data phase, set said second data signal to a value generated by combining data received via said first data signal with part of said encrypted address,
wait until said second ready signal received from said memory controller is asserted, and
in response to determining that said second ready signal is asserted, assert said first ready signal.

2. The processing system according to claim 1, wherein said memory cipher engine circuit is configured to determine said address data indicating a memory area of K bytes in said memory comprising a given address by selecting a given number of most significant bits of said first address signal, and
wherein said memory cipher engine circuit is configured to set said second data signal to said value generated by combining data received with said first data signal with part of said encrypted address by:
splitting said encrypted address into K/N subsets of bits,
selecting one of said subsets of bits as a function of a given number of least significant bits of said first address signal, and
setting said second data signal to a value generated by combining data received via said first data signal with said selected subsets of bits via a logic XOR operation.

3. The processing system according to claim 1, wherein said write request to said first address indicates a non-sequential transmission, wherein said memory cipher engine circuit is configured to receive from said processing circuit via said first address signal and said first control signal a write request to a second address, said write request to said second address indicating a non-sequential transmission, and, in response to receiving said write request to said second address:
determine address data indicating a memory area of K bytes in said memory comprising said second address,
determine whether said determined address data correspond to said stored address data,
in response to determining that said determined address data correspond to said stored address data,
forward said first address signal and said first control signal as said second address signal and said second control signal, thereby indicating a write request to said second address and, in a following data phase, set said second data signal to a value generated by combining data received with said first data signal with part of said encrypted address, forward said second ready signal received from said memory controller as said first ready signal,
in response to determining that said determined address data do not correspond to said stored address data,
store said determined address data,
deassert said first ready signal provided to said processing circuit and set said second data signal to a given value,
provide said determined address data to said block cipher cryptographic circuit, and assert said encryption-request signal,
wait until said encryption-ready signal is asserted,
in response to determining that said encryption-ready signal is asserted, set said second address signal and said second control signal to indicate a non-sequential write request to said second address and, in a following data phase, set said second data signal to a value generated by combining data received with said first data signal with part of said encrypted address,
wait until said second ready signal received from said memory controller is asserted, and
in response to determining that said second ready signal is asserted, assert said first ready signal.

4. The processing system according to claim 1, wherein said memory cipher engine circuit is configured to receive from said processing circuit via said first address signal and said first control signal a write request to a third address, said write request to said third address indicating a sequential transmission, and, in response to receiving said write request to said third address:
determine address data indicating a memory area of K bytes in said memory comprising said third address,
determine whether said determined address data correspond to said stored address data,
in response to determining that said determined address data correspond to said stored address data,
forward said first address signal and said first control signal as said second address signal and said second control signal, thereby indicating a write request to said third address and, in a following data phase, set said second data signal to a value generated by combining data received with said first data signal with part of said encrypted address,
forward said second ready signal received from said memory controller as said first ready signal,
in response to determining that said determined address data do not correspond to said stored address data,
store said determined address data,
deassert said first ready signal provided to said processing circuit, set said second data signal to a given value, and set said second control signal to indicate an idle state,
provide said determined address data to said block cipher cryptographic circuit, and assert said encryption-request signal,
wait until said encryption-ready signal is asserted, and in response to determining that said encryption-ready signal is asserted:
set said second address signal and said second control signal to indicate a non-sequential write request to said third address,
wait until said second ready signal received from said memory controller is asserted, and in response to determining that said second ready signal received from said memory controller is asserted:
maintain deasserted said first ready signal provided to said processing circuit,
set said second data signal to a value generated by combining data received with said first data signal with part of said encrypted address,
wait until said second ready signal received from said memory controller is asserted, and in response to determining that said second ready signal is asserted, assert said first ready signal.

5. The processing system according to claim 1, wherein each of said first communication system and said second communication system is an Advanced Microcontroller Bus Architecture, AMBA, High-performance Bus, AHB, or an AHB Lite bus.

6. The processing system according to claim 5, wherein said memory cipher engine circuit comprises:
an address comparison circuit comprising a memory configured to store address data, wherein said address comparison circuit is configured to:
determine address data indicating a memory area of K bytes in said memory comprising the address transmitted with said first address signal,
determine whether said determined address data correspond to said stored address data, and
in response to determining that said determined address data correspond to said stored address data, assert said encryption-request signal and store said determined address data to said memory;
a transfer management circuit configured to receive a first transfer type signal and a first burst type signal from said processing circuit, and generate a second transfer type signal and a second burst type signal for to said memory controller as a function of first flow control signals;
a buffer circuit configured to receive said first address signal and a first transfer direction signal from said processing circuit, and generate said second address signal and a second transfer direction signal for to said memory controller as a function of second flow control signals;
an encryption management circuit comprising said block cipher cryptographic circuit, wherein said encryption management circuit is configured to receive said first data signal and generate said second data signal as a function of third flow control signals;
a flow control circuit configured to receive said first transfer direction signal and said first transfer type signal from said processing circuit and said encryption-request signal from said address comparison circuit, and generate said first flow control signals, said second flow control signals and said third flow control signals.

7. The processing system according to claim 6, wherein said flow control circuit is configured to:
determine whether a new write request is received and said encryption-request signal is asserted,
in response to determining that said new write request is received and said encryption-request signal is asserted, assert a postpone write request control signal,
in response to determining that said encryption-ready signal is asserted:
assert a write request control signal, and
deassert the postpone write request control signal.

8. The processing system according to claim 7, wherein said flow control circuit is configured to:
determine whether a new sequential or non-sequential write request is received and whether said encryption-request signal is asserted,
in response to determining that a new non-sequential write request is received and said encryption-request signal is asserted:
determine whether said encryption-ready signal is asserted,
in response to determining that said encryption-ready signal is deasserted, deassert said first ready signal,
in response to determining that said encryption-ready signal is asserted, provide said second ready signal as said first ready signal,
in response to determining that a new sequential write request is received and said encryption-request signal is asserted:
assert a ready control signal, wherein said flow control circuit is configured to maintain deasserted said first ready signal while said ready control signal is asserted, and
in response to determining that said second ready signal received from said memory controller is asserted, deassert said ready control signal.

9. The processing system according to claim 8, wherein said encryption management circuit is configured to:
determine whether said postpone write request control signal is asserted or said ready control signal is asserted,
in response to determining that said postpone write request control signal is asserted or said ready control signal is asserted, provide said given value as said second data signal,
in response to determining that said postpone write request control signal and said ready control signal are deasserted, set said second data signal to said value generated by combining data received via said first data signal with part of said encrypted address.

10. The processing system according to claim 8, wherein said flow control circuit is configured to:
in response to determining that a new sequential or non-sequential write request is received and said encryption-request signal is deasserted, set said first flow control signals, such that said transfer management circuit provides said first transfer type signal;
in response to determining that a new non-sequential write request is received and said encryption-request signal is asserted, set said first flow control signals, such that said transfer management circuit provides said value indicating an idle state until said write request control signal is asserted and then said value indicating a non-sequential data transmission, whereby the communication with said memory controller is maintained in the idle state until said encryption-ready signal is asserted and a non-sequential write request is transmitted to said memory controller;
in response to determining that a new sequential write request is received and said encryption-request signal is asserted, set said first flow control signals, such that said transfer management circuit provides said value indicating an idle state until said write request control signal is asserted and then said value indicating a non-sequential data transmission, whereby a sequential communication with said memory controller is interrupted and a new non-sequential write request is transmitted to said memory controller.

11. The processing system according to claim 8, wherein said buffer circuit is configured to:
provide said first address signal as said second address signal; and
in response to determining that said write request control signal is asserted, provide a stored version of said first address signal as said second address signal.

12. A method for writing data to a memory in a processing system, comprising:
receiving, via a first address signal and a first control signal, a write request to a first address;
determining address data indicating a memory area of K bytes in the memory that comprises the first address;
storing the address data;
deasserting a first ready signal and setting a second data signal to a given value;
providing the address data to a block cipher cryptographic circuit and asserting an encryption-request signal;
waiting until an encryption-ready signal is asserted;
in response to the encryption-ready signal being asserted:
setting a second address signal and a second control signal to indicate a write request to the first address; and
setting, in a following data phase, the second data signal to a value generated by combining data received via a first data signal with part of an encrypted address;
waiting until a second ready signal is asserted; and
asserting the first ready signal in response to the second ready signal being asserted.

13. The method of claim 12, further comprising:
determining the address data indicating a memory area of K bytes in the memory by selecting a given number of most significant bits of the first address signal; and
setting the second data signal to a value generated by combining data received via the first data signal with part of the encrypted address by:
splitting the encrypted address into K/N subsets of bits, where N is a given number of bytes per memory slot of the memory;
selecting one of the subsets of bits as a function of a given number of least significant bits of the first address signal; and
combining the data received via the first data signal with the selected subset of bits using a logic XOR operation.

14. The method according to claim 12, further comprising:
receiving a write request to a second address indicating a non-sequential transmission;
determining address data indicating a memory area of K bytes in the memory comprising the second address;
comparing the determined address data with the stored address data;
in response to the determined address data corresponding to the stored address data:
forwarding the first address signal and first control signal as the second address signal and second control signal to indicate a write request to the second address;
setting, in a following data phase, the second data signal to a value generated by combining data received via the first data signal with part of the encrypted address; and
forwarding the second ready signal as the first ready signal;
in response to the determined address data not corresponding to the stored address data:
storing the determined address data;
deasserting the first ready signal and setting the second data signal to a given value;
providing the determined address data to the block cipher cryptographic circuit and asserting the encryption-request signal;
waiting until the encryption-ready signal is asserted; and
setting the second address signal and second control signal to indicate a non-sequential write request to the second address and, in a following data phase, setting the second data signal to a value generated by combining data received via the first data signal with part of the encrypted address.
